(19) United States
(12) Patent Application Publication
(10) Pub. No.: US 2025/0276765 A1
(43) Pub. Date: Sep. 4, 2025

(54) WASTE CONTAINER AND VALVE APPARATUS THEREFOR

(71) Applicant: Inca Products Acquisition Corp., Sparta, TN (US)

(72) Inventors: Michael HASHEM, Wooster, OH (US); Luke Shoaf, Cookeville, TN (US); Cody Allen, Cookeville, TN (US)

(21) Appl. No.: 19/066,813

(22) Filed: Feb. 28, 2025

Related U.S. Application Data
(60) Provisional application No. 63/561,084, filed on Mar. 4, 2024.
(60) Provisional application No. 63/656,142, filed on Jun. 5, 2024.

(51) Int. Cl. B63B 17/06; B63B 29/14; B63B 29/16; B63B 73/20

(52) U.S. Cl. CPC B63B 17/06; B63B 29/14; B63B 29/16; B63B 73/20

(57) ABSTRACT

Aspects of the present disclosure provide waste containers for waste management on a vehicle, such as a watercraft. A waste container for use on a vehicle may include at least one wall comprising an inner surface defining a chamber for holding waste, and a plurality of projections projecting from the inner surface of the at least one wall into the chamber. Aspects of the present disclosure also provide valve apparatuses for controlling flow of waste into or out of a waste container. Such a valve apparatus may include a non-dismantlable valve body defining a flow channel for conveying waste, and at least one check valve secured within the flow channel and configured to allow waste to flow from an inlet to an outlet of the flow channel and to prevent waste from flowing from the outlet to the inlet.

### CROSS-REFERENCE TO RELATED APPLICATION

This application claims the benefit of, and priority to, U.S. provisional patent application No. 63/561,084 filed Mar. 4, 2024, the entire contents of which are incorporated by reference herein. This application also claims the benefit of, and priority to, U.S. provisional patent application No. 63/656,142 filed Jun. 5, 2024, the entire contents of which are incorporated by reference herein.

### FIELD

This disclosure relates generally to containers and valves for waste management on a vehicle, such as a watercraft.

### BACKGROUND

Vehicles such as watercraft may include waste containers, valves, and pumps for storing and managing waste onboard. However, over time, solid wastes may accumulate in a waste container and may block routes for emptying the container. Additionally, maintenance of valves in existing onboard waste management systems may be overly complex.

### SUMMARY

According to at least one embodiment, there is disclosed a waste container for use on a vehicle, the waste container comprising: at least one wall comprising an inner surface defining a chamber for holding waste; and a plurality of projections projecting from the inner surface of the at least one wall into the chamber.

In some embodiments, the projections are configured to disturb flow of waste in the chamber as movement of the vehicle causes the waste in the chamber to move in the chamber.

In some embodiments, the projections are configured to generate turbulence in the waste in the chamber as the movement of the vehicle causes the waste in the chamber to move in the chamber.

In some embodiments, the projections are configured to break apart solids in the waste in the chamber as the movement of the vehicle causes the waste in the chamber to move in the chamber.

In some embodiments, the projections are configured to disperse particles in the waste in the chamber as the movement of the vehicle causes the waste in the chamber to move in the chamber.

In some embodiments, the movement of the vehicle comprises tilting of the vehicle.

In some embodiments, at least one of the plurality of projections extends along the inner surface without contacting any other one of the plurality of projections.

In some embodiments, each of the plurality of projections extends along the inner surface without contacting any other one of the plurality of projections.

In some embodiments, at least some of the plurality of projections extend along the inner surface parallel to one another.

In some embodiments, adjacent ones of the plurality of projections along the inner surface, which extend parallel to one another along the inner surface, are spaced apart from one another at a fixed projection spacing in a spacing direction along the inner surface, the spacing direction perpendicular to an extension direction along the inner surface of the adjacent ones of the plurality of projections.

In some embodiments, the projection spacing is at most 1 inch.

In some embodiments, the projection spacing is about 1 inch.

In some embodiments, the projection spacing is at least 1 inch.

In some embodiments, the projection spacing is at most 2 inches.

In some embodiments, the projection spacing is about 2 inches. In some embodiments, each of the plurality of projections extends along the inner surface in a substantially vertical or vertical direction when the waste container is installed on the vehicle.

In some embodiments, each of the plurality of projections projects from a respective portion of the inner surface in a respective projection direction generally orthogonal or orthogonal to the respective portion of the inner surface.

In some embodiments, at least a portion of each of the plurality of projections projects at least 0.5 inches from the inner surface.

In some embodiments, all of each of the plurality of projections projects at least 0.5 inches from the inner surface.

In some embodiments, at least a portion of each of the plurality of projections projects about 0.5 inches from the inner surface.

In some embodiments, all of each of the plurality of projections projects about 0.5 inches from the inner surface.

In some embodiments, at least a portion of each of the plurality of projections projects at least 1.25 inches from the inner surface.

In some embodiments, all of each of the plurality of projections projects at least 1.25 inches from the inner surface.

In some embodiments, at least a portion of each of the plurality of projections projects about 1.25 inches from the inner surface.

In some embodiments, all of each of the plurality of projections projects about 1.25 inches from the inner surface.

In some embodiments, each of the plurality of projections projects at most 0.5 inches from the inner surface.

In some embodiments, each of the plurality of projections projects at most 1.25 inches from the inner surface.

In some embodiments, the at least one wall further defines at least one opening in the chamber for conveying waste into and out of the chamber.

In some embodiments, the at least one opening is closable.

In some embodiments, at least one of the at least one opening is at a top of the chamber or a bottom of the chamber when the waste container is installed on the vehicle.

In some embodiments, the at least one opening comprises: at least one inlet for receiving waste into the chamber; and at least one outlet for removing waste from the chamber.

In some embodiments, the at least one outlet comprises a bottom outlet positioned to be at the bottom of the chamber when the waste container is installed on the vehicle.

In some embodiments, the waste container further comprises a valve operable to reversibly close the bottom outlet.

In some embodiments, the valve is a ball valve.

In some embodiments, the bottom outlet is configured to be in fluid communication with a seacock on a hull of the vehicle when the waste container is installed on the vehicle.

In some embodiments, the at least one outlet comprises a top outlet positioned to be at the top of the chamber when the waste container is installed on the vehicle.

In some embodiments, the waste container further comprises a dip tube extending from the top outlet into the chamber, the dip tube in fluid communication with the top outlet and with the chamber.

In some embodiments, the top outlet is configured to be in fluid communication with a pump-out fitting of the vehicle when the waste container is installed on the vehicle.

In some embodiments, the at least one inlet comprises a top inlet positioned to be at the top of the chamber when the waste container is installed on the vehicle.

In some embodiments, the at least one inlet is configured to be in fluid communication with a toilet onboard the vehicle when the waste container is installed on the vehicle.

In some embodiments, the at least one inlet is configured to be in fluid communication with a sink onboard the vehicle when the waste container is installed on the vehicle.

In some embodiments, the at least one inlet is configured to be in fluid communication with a shower onboard the vehicle when the waste container is installed on the vehicle.

In some embodiments, each of the plurality of projections extends along at least a portion of the inner surface between one of the at least one inlet and one of the at least one outlet.

In some embodiments, the at least one wall comprises a plurality of walls.

In some embodiments, at least some of the plurality of walls are parallel to one another.

In some embodiments, at least one of the plurality of projections projects from each of the plurality of walls.

In some embodiments, none of the plurality of projections project from at least one of the plurality of walls.

In some embodiments, the vehicle is a marine vessel.

In some embodiments, the waste container is installed on the vehicle.

According to at least another embodiment, there is disclosed a method of manufacturing the waste container, the method comprising molding the at least one wall with the plurality of projections.

According to at least another embodiment, there is disclosed a method of manufacturing the waste container, the method comprising: molding the at least one wall; and fixing the plurality of projections to the inner surface.

In some embodiments, molding the at least one wall comprises rotational molding the at least one wall.

In some embodiments, molding the at least one wall comprises injection molding the at least one wall.

According to at least another embodiment, there is disclosed a system comprising: the waste container; and the vehicle, wherein the waste container is installed on the vehicle.

According to at least another embodiment, there is disclosed a use of the waste container for waste management on the vehicle.

According to at least another embodiment, there is disclosed a valve apparatus for controlling flow of waste into or out of a waste container, the valve apparatus comprising a non-dismantlable valve body defining a flow channel for conveying the waste, the flow channel comprising a channel inlet for receiving the waste into the flow channel and a channel outlet for removing the waste from the flow channel; and at least one check valve secured within the flow channel, the at least one check valve configured to: allow the waste to flow through the flow channel in a forward flow direction from the channel inlet to the channel outlet; and prevent the waste from flowing through the flow channel in a reverse flow direction from the channel outlet to the channel inlet.

In some embodiments, the valve apparatus is for use with a pump for controlling the flow of the waste into or out of the waste container.

In some embodiments, the pump comprises a vacuum pump.

In some embodiments, the valve body comprises an inlet end defining the channel inlet, the inlet end connectable to a waste source to cause the flow channel to be in fluid communication with the waste source through the channel inlet.

In some embodiments, the valve apparatus further comprises a channel inlet clamp operable to releasably secure the inlet end to the waste source to connect the inlet end to the waste source to cause the flow channel to be in fluid communication with the waste source through the channel inlet.

In some embodiments, the inlet end comprises at least one inlet end interlocking portion, the at least one inlet end interlocking portion releasably interlockable with a corresponding waste source interlocking portion of the waste source to releasably secure the inlet end to the waste source to connect the inlet end to the waste source to cause the flow channel to be in fluid communication with the waste source through the channel inlet.

In some embodiments, the at least one inlet end interlocking portion is releasably interlockable with the waste source interlocking portion by rotation of the valve apparatus relative to the waste source.

In some embodiments, the rotation of the valve apparatus relative to the waste source is around an inlet channel axis parallel to the flow channel at the channel inlet.

In some embodiments, the at least one inlet end interlocking portion projects from the valve body at the inlet end.

In some embodiments, the at least one inlet end interlocking portion projects out from the valve body away from the flow channel.

In some embodiments, the inlet end comprises an inlet end mating surface around the channel inlet, the inlet end mating surface configured to engage with a corresponding waste source mating surface of the waste source when the inlet end is connected to the waste source to cause the flow channel to be in fluid communication with the waste source through the channel inlet.

In some embodiments, the valve apparatus further comprises a channel inlet seal seated on the inlet end mating surface around the channel inlet, the channel inlet seal configured to seal an interface between the inlet end mating surface and the waste source mating surface when the inlet end mating surface engages with the waste source mating surface.

In some embodiments, the channel inlet seal comprises a face seal.

In some embodiments, the channel inlet seal comprises an O-ring.

In some embodiments, the waste source comprises the waste container.

In some embodiments, the waste source comprises the vacuum pump.

In some embodiments, the valve body comprises an outlet end defining the channel outlet, the outlet end connectable to a waste destination to cause the flow channel to be in fluid communication with the waste destination through the channel outlet.

In some embodiments, the valve apparatus further comprises a channel outlet clamp operable to releasably secure the outlet end to the waste destination to connect the outlet end to the waste destination to cause the flow channel to be in fluid communication with the waste destination through the channel outlet.

In some embodiments, the outlet end comprises at least one outlet end interlocking portion, the at least one outlet end interlocking portion releasably interlockable with a corresponding waste destination interlocking portion of the waste destination to releasably secure the outlet end to the waste destination to connect the outlet end to the waste destination to cause the flow channel to be in fluid communication with the waste destination through the channel outlet.

In some embodiments, the at least one outlet end interlocking portion is releasably interlockable with the waste destination interlocking portion by rotation of the valve apparatus relative to the waste destination.

In some embodiments, the rotation of the valve apparatus relative to the waste destination is around an outlet channel axis parallel to the flow channel at the channel outlet.

In some embodiments, the at least one outlet end interlocking portion projects from the valve body at the outlet end.

In some embodiments, the at least one outlet end interlocking portion projects out from the valve body away from the flow channel.

In some embodiments, the outlet end comprises an outlet end mating surface around the channel outlet, the outlet end mating surface configured to engage with a corresponding waste destination mating surface of the waste destination when the outlet end is connected to the waste destination to cause the flow channel to be in fluid communication with the waste destination through the channel outlet.

In some embodiments, the valve apparatus further comprises a channel outlet seal seated on the outlet end mating surface around the channel outlet, the channel outlet seal configured to seal an interface between the outlet end mating surface and the waste destination mating surface when the outlet end mating surface engages with the waste destination mating surface.

In some embodiments, the channel outlet seal comprises a face seal.

In some embodiments, the channel outlet seal comprises an O-ring.

In some embodiments, the waste destination comprises the waste container.

In some embodiments, the waste destination comprises the vacuum pump.

In some embodiments, the valve body comprises a plurality of valve body portions between the channel inlet and the channel outlet, the plurality of valve body portions collectively defining the flow channel, each valve body portion of the plurality of valve body portions fixed to at least one other valve body portion of the plurality of valve body portions.

In some embodiments, at least two of the valve body portions of the plurality of valve body portions are fixed together by plastic welding.

In some embodiments, at least two of the valve body portions of the plurality of valve body portions are fixed together by glue.

In some embodiments, at least one valve body portion of the plurality of valve body portions retains the check valve.

In some embodiments, the at least one check valve comprises at least one duckbill valve.

In some embodiments, the at least one duckbill valve comprises a first duckbill valve and a second duckbill valve.

In some embodiments, the first duckbill valve and the second duckbill valve are non-overlapping in the forward flow direction.

In some embodiments, at least a portion of the first duckbill valve is received in the second duckbill valve.

In some embodiments, the first duckbill valve is nested within the second duckbill valve.

In some embodiments, the valve apparatus is for controlling the flow of the waste into or out of the waste container disclosed above.

According to at least another embodiment, there is disclosed a method of installing the valve apparatus to the waste source, the method comprising: causing the channel inlet clamp to the secure the inlet end to the waste source.

According to at least another embodiment, there is disclosed a method of installing the valve apparatus to the waste source, the method comprising: rotating the valve apparatus relative to the waste source to interlock the at least one inlet end interlocking portion with the waste source interlocking portion.

According to at least another embodiment, there is disclosed a method of installing the valve apparatus to the waste destination, the method comprising: causing the channel outlet clamp to the secure the outlet end to the waste destination.

According to at least another embodiment, there is disclosed a method of installing the valve apparatus to the waste destination, the method comprising: rotating the valve apparatus relative to the waste destination to interlock the at least one outlet end interlocking portion with the waste destination interlocking portion.

According to at least another embodiment, there is disclosed a system comprising: the valve apparatus; and the waste container, wherein: the waste container comprises at least one wall comprising an inner surface defining a chamber for holding the waste; and the flow channel of the valve apparatus is in fluid communication with the chamber of the waste container.

In some embodiments, the at least one wall of the waste container defines a container outlet for removing the waste from the waste container; and the flow channel of the valve apparatus is in fluid communication with the chamber of the waste container through the container outlet of the waste container and through the channel inlet of the valve apparatus.

In some embodiments, the inlet end of the valve apparatus is connected to the waste container at the container outlet of the waste container.

In some embodiments, the channel inlet clamp of the valve apparatus releasably secures the inlet end of the valve apparatus to the waste container at the container outlet of the waste container.

In some embodiments, the waste container further comprises at least one waste container outlet interlocking portion at the container outlet, the at least one waste container outlet interlocking portion releasably interlocked with a corresponding one of the at least one inlet end interlocking portion of the inlet end of the valve apparatus to releasably secure the inlet end of the valve apparatus to the waste container at the container outlet of the waste container.

In some embodiments, the inlet end mating surface of the valve apparatus engages with a corresponding container outlet mating surface of the waste container.

In some embodiments, the channel inlet seal of the valve apparatus seals an interface between the inlet end mating surface of the valve apparatus and the container outlet mating surface of the waste container.

In some embodiments, the at least one wall of the waste container defines a container inlet for receiving the waste into the waste container; and the flow channel of the valve apparatus is in fluid communication with the waste container through the container inlet of the waste container and through the channel outlet of the valve apparatus.

In some embodiments, the outlet end of the valve apparatus is connected to the waste container at the container inlet of the waste container.

In some embodiments, the channel outlet clamp of the valve apparatus releasably secures the outlet end of the valve apparatus to the waste container at the container inlet of the waste container.

In some embodiments, the waste container further comprises at least one waste container inlet interlocking portion at the container inlet, the at least one waste container inlet interlocking portion releasably interlocked with a corresponding one of the at least one outlet end interlocking portion of the outlet end of the valve apparatus to releasably secure the outlet end of the valve apparatus to the waste container at the container inlet of the waste container.

In some embodiments, the outlet end mating surface of the valve apparatus engages with a corresponding container inlet mating surface of the waste container.

In some embodiments, the channel outlet seal of the valve apparatus seals an interface between the outlet end mating surface of the valve apparatus and the container inlet mating surface of the waste container.

In some embodiments, the waste container comprises the waste container disclosed above.

According to at least another embodiment, there is disclosed a vacuum pump system for controlling flow of waste into or out of a waste container, the vacuum pump system comprising: a vacuum pump operable to cause the waste to flow, the vacuum pump defining a pump inlet for receiving the waste into the vacuum pump and a pump outlet for removing the waste from the vacuum pump; and a first one of the valve apparatus disclosed above, wherein the flow channel of the first one of the valve apparatus is in fluid communication with the vacuum pump.

In some embodiments, the flow channel of the first one of the valve apparatus is in fluid communication with the vacuum pump through the pump outlet of the vacuum pump and through the channel inlet of the first one of the valve apparatus.

In some embodiments, the inlet end of the first one of the valve apparatus is connected to the vacuum pump at the pump outlet of the vacuum pump.

In some embodiments, the channel inlet clamp of the first one of the valve apparatus releasably secures the inlet end of the first one of the valve apparatus to the vacuum pump at the pump outlet of the vacuum pump.

In some embodiments, the vacuum pump further comprises at least one vacuum pump outlet interlocking portion at the pump outlet, the at least one vacuum pump outlet interlocking portion releasably interlocked with a corresponding one of the at least one inlet end interlocking portion of the inlet end of the first one of the valve apparatus to releasably secure the inlet end of the first one of the valve apparatus to the vacuum pump at the pump outlet of the vacuum pump.

In some embodiments, the inlet end mating surface of the first one of the valve apparatus engages with a corresponding pump outlet mating surface of the vacuum pump.

In some embodiments, the channel inlet seal of the first one of the valve apparatus seals an interface between the inlet end mating surface of the first one of the valve apparatus and the pump outlet mating surface of the vacuum pump.

In some embodiments, the flow channel of the first one of the valve apparatus is in fluid communication with the vacuum pump through the pump inlet of the vacuum pump and through the channel outlet of the first one of the valve apparatus.

In some embodiments, the outlet end of the first one of the valve apparatus is connected to the vacuum pump at the pump inlet of the vacuum pump.

In some embodiments, the channel outlet clamp of the first one of the valve apparatus releasably secures the outlet end of the first one of the valve apparatus to the vacuum pump at the pump inlet of the vacuum pump.

In some embodiments, the vacuum pump further comprises at least one vacuum pump inlet interlocking portion at the pump inlet, the at least one vacuum pump inlet interlocking portion releasably interlocked with a corresponding one of the at least one outlet end interlocking portion of the outlet end of the first one of the valve apparatus to releasably secure the outlet end of the first one of the valve apparatus to the vacuum pump at the pump inlet of the vacuum pump.

In some embodiments, the outlet end mating surface of the first one of the valve apparatus engages with a corresponding pump inlet mating surface of the vacuum pump.

In some embodiments, the channel outlet seal of the first one of the valve apparatus seals an interface between the outlet end mating surface of the first one of the valve apparatus and the pump inlet mating surface of the vacuum pump.

In some embodiments, the vacuum pump system further comprises a second one of the valve apparatus disclosed above, wherein the flow channel of the second one of the valve apparatus is in fluid communication with the vacuum pump through the pump outlet of the vacuum pump and through the channel inlet of the second one of the valve apparatus.

In some embodiments, the inlet end of the second one of the valve apparatus is connected to the vacuum pump at the pump outlet of the vacuum pump.

In some embodiments, the channel inlet clamp of the second one of the valve apparatus releasably secures the inlet end of the second one of the valve apparatus to the vacuum pump at the pump outlet of the vacuum pump.

In some embodiments, the vacuum pump further comprises at least one vacuum pump outlet interlocking portion at the pump outlet, the at least one vacuum pump outlet interlocking portion releasably interlocked with a corresponding one of the at least one inlet end interlocking portion of the inlet end of the second one of the valve apparatus to releasably secure the inlet end of the second one of the valve apparatus to the vacuum pump at the pump outlet of the vacuum pump.

In some embodiments, the inlet end mating surface of the second one of the valve apparatus engages with a corresponding pump outlet mating surface of the vacuum pump.

In some embodiments, the channel inlet seal of the second one of the valve apparatus seals an interface between the inlet end mating surface of the second one of the valve apparatus and the pump outlet mating surface of the vacuum pump.

In some embodiments, the vacuum pump system is for controlling the flow of the waste into or out of the waste container disclosed above

According to at least another embodiment, there is disclosed a system comprising: the vacuum pump system as disclosed above; and the waste container, wherein: the waste container comprises at least one wall comprising an inner surface defining a chamber for holding the waste; and the vacuum pump system is in fluid communication with the chamber of the waste container.

In some embodiments, the flow channel of the first one of the valve apparatus of the vacuum pump system is in fluid communication with the chamber of the waste container.

In some embodiments, the at least one wall of the waste container defines a container inlet for receiving the waste into the waste container; and the flow channel of the first one of the valve apparatus of the vacuum pump system is in fluid communication with the chamber of the waste container through the container inlet of the waste container and through the channel outlet of the first one of the valve apparatus of the vacuum pump system.

In some embodiments, the outlet end of the first one of the valve apparatus of the vacuum pump system is connected to the waste container at the container inlet of the waste container.

In some embodiments, the channel outlet clamp of the first one of the valve apparatus of the vacuum pump system releasably secures the outlet end of the first one of the valve apparatus of the vacuum pump system to the waste container at the container inlet of the waste container.

In some embodiments, the waste container further comprises at least one waste container inlet interlocking portion at the container inlet, the at least one waste container inlet interlocking portion releasably interlocked with a corresponding one of the at least one outlet end interlocking portion of the outlet end of the first one of the valve apparatus to releasably secure the outlet end of the first one of the valve apparatus to the waste container at the container inlet of the waste container.

In some embodiments, the outlet end mating surface of the first one of the valve apparatus of the vacuum pump system engages with a corresponding container inlet mating surface of the waste container.

In some embodiments, the channel outlet seal of the first one of the valve apparatus of the vacuum pump system seals an interface between the outlet end mating surface of the first one of the valve apparatus of the vacuum pump system and the container inlet mating surface of the waste container.

In some embodiments, the at least one wall of the waste container defines a container outlet for receiving the waste into the waste container; and the flow channel of the first one of the valve apparatus of the vacuum pump system is in fluid communication with the chamber of the waste container through the container outlet of the waste container and through the channel inlet of the first one of the valve apparatus of the vacuum pump system.

In some embodiments, the inlet end of the first one of the valve apparatus of the vacuum pump system is connected to the waste container at the container outlet of the waste container.

In some embodiments, the channel inlet clamp of the first one of the valve apparatus of the vacuum pump system releasably secures the inlet end of the first one of the valve apparatus of the vacuum pump system to the waste container at the container outlet of the waste container.

In some embodiments, the waste container further comprises at least one waste container outlet interlocking portion at the container outlet, the at least one waste container outlet interlocking portion releasably interlocked with a corresponding one of the at least one inlet end interlocking portion of the inlet end of the first one of the valve apparatus to releasably secure the inlet end of the first one of the valve apparatus to the waste container at the container outlet of the waste container.

In some embodiments, the inlet end mating surface of the first one of the valve apparatus of the vacuum pump system engages with a corresponding container outlet mating surface of the waste container.

In some embodiments, the channel inlet seal of the first one of the valve apparatus of the vacuum pump system seals an interface between the inlet end mating surface of the first one of the valve apparatus of the vacuum pump system and the container outlet mating surface of the waste container.

In some embodiments, the at least one wall of the waste container defines a container inlet for receiving the waste into the waste container; and the flow channel of the second one of the valve apparatus of the vacuum pump system is in fluid communication with the chamber of the waste container through the container inlet of the waste container and through the channel outlet of the second one of the valve apparatus of vacuum pump system.

In some embodiments, the outlet end of the second one of the valve apparatus of the vacuum pump system is connected to the waste container at the container inlet of the waste container.

In some embodiments, the channel outlet clamp of the second one of the valve apparatus of the vacuum pump system releasably secures the outlet end of the second one of the valve apparatus of the vacuum pump system to the waste container at the container inlet of the waste container.

In some embodiments, the waste container further comprises at least one waste container inlet interlocking portion at the container inlet, the at least one waste container inlet interlocking portion releasably interlocked with a corresponding one of the at least one outlet end interlocking portion of the outlet end of the second one of the valve apparatus to releasably secure the outlet end of the second one of the valve apparatus to the waste container at the container inlet of the waste container.

In some embodiments, the outlet end mating surface of the second one of the valve apparatus of the vacuum pump system engages with a corresponding container inlet mating surface of the waste container.

In some embodiments, the channel outlet seal of the second one of the valve apparatus of the vacuum pump system seals an interface between the outlet end mating surface of the second one of the valve apparatus of the vacuum pump system and the container inlet mating surface of the waste container.

In some embodiments, the waste container comprises the waste container disclosed above.

According to at least another embodiment, there is disclosed a kit comprising: the waste container disclosed above; and at least one of the valve apparatus disclosed above.

In some embodiments, the kit further comprises a pump.

In some embodiments, the pump comprises a vacuum pump.

In some embodiments, the at least one of the valve apparatus disclosed above comprises at least two of the valve apparatus disclosed above.

Other aspects and features will become apparent to those ordinarily skilled in the art upon review of the following description of illustrative embodiments in conjunction with the accompanying figures.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic plan view of a watercraft according to one embodiment.

FIG. 2 is a perspective view of a waste container according to one embodiment.

FIG. 3 is a side view of the waste container of FIG. 2.

FIG. 4 is a cutaway perspective view of the waste container of FIG. 2.

FIG. 5 is a perspective view of the waste container of FIG. 2 with an inlet pipe, outlet pipes, a top wall, and a dip tube of the waste container removed.

FIG. 6 is a cutaway perspective view of the waste container of FIG. 5, taken along the line labelled FIGS. 6, 7 in FIG. 5.

FIG. 7 is a cross-sectional view of the waste container of FIG. 5, taken along the line labelled FIGS. 6, 7 in FIG. 5.

FIG. 8 is a plan view of the waste container of FIG. 5.

FIG. 9 is a perspective view of a waste container and vacuum pump system according to another embodiment.

FIG. 10 is a cross-sectional view of the waste container of FIG. 9, taken along the line labelled FIG. 10 in FIG. 9.

FIG. 11 is an exploded view of the vacuum pump system of FIG. 9.

FIG. 12 is a perspective view of a valve apparatus of the vacuum pump system of FIG. 9.

FIG. 13 is a perspective view of the valve apparatus of FIG. 12, with a channel inlet clamp and a channel outlet clamp removed.

FIG. 14 is a cross-sectional view of the valve apparatus of FIG. 12, taken along the line labelled FIG. 14 in FIG. 12.

FIG. 15 is a perspective exploded view of a vacuum pump system according to another embodiment.

FIG. 16 is a front exploded view of the vacuum pump system of FIG. 15.

FIG. 17 is a front view of the vacuum pump system of FIG. 15 when assembled.

FIG. 18 is a perspective view of a valve apparatus of the vacuum pump system of FIG. 15.

FIG. 19 is a cross-sectional view of the valve apparatus of FIG. 18, taken along the line labelled FIG. 19 in FIG. 18.

### DETAILED DESCRIPTION

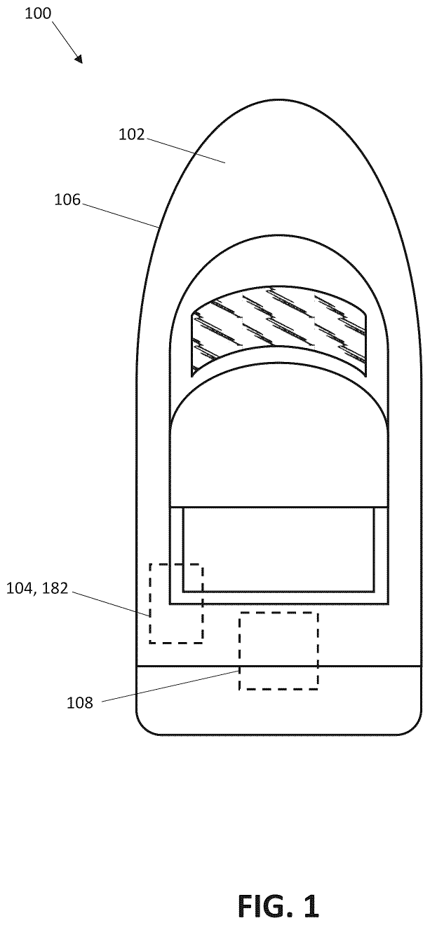

Referring to FIG. 1, a vehicle waste management system according to one embodiment is shown generally at 100 and includes a watercraft 102 and a waste container 104. In some embodiments, the watercraft 102 may be, for example, a wake boat, a water-ski boat, or another boat, aquatic vessel, or marine vessel. However, the watercraft 102 is an example only, and alternative embodiments may differ. For example, alternative embodiments may include a vehicle other than a watercraft, such as an aircraft or a recreational vehicle.

The watercraft 102 includes a hull 106 and an inboard engine 108 operable to generate an engine thrust force relative to the hull 106. The engine thrust force generated by the inboard engine 108 may cause the watercraft 102 to move. The watercraft 102 may also move in response to external forces, such as wave action on the hull 106. For example, the engine thrust force and/or the wave action may cause the watercraft 102 to move in a tilting motion. The inboard engine 108 is an example only, and alternative embodiments may differ. For example, alternative embodiments may include an inboard engine, a sterndrive engine, a jet-drive engine, a thruster engine, a surface-drive engine, a pod-drive engine, or any other engine or propulsion device, and alternative embodiments may include one, two, or more than two such engines or other propulsion devices.

In the embodiment shown, the waste container 104 is installed on the watercraft 102 within the hull 106 and is generally operable to receive and manage waste onboard the watercraft 102. The waste container 104 may also be referred to as a “waste containment tank” or a “waste holding tank”. As used herein, the term “waste” may include, for example, liquid waste, solid waste, slurry, human waste, tissue, wastewater, used water, blackwater, and greywater. The waste container 104 may receive the waste, for example, from a toilet, sink, shower, or the like (not shown) onboard the watercraft 102.

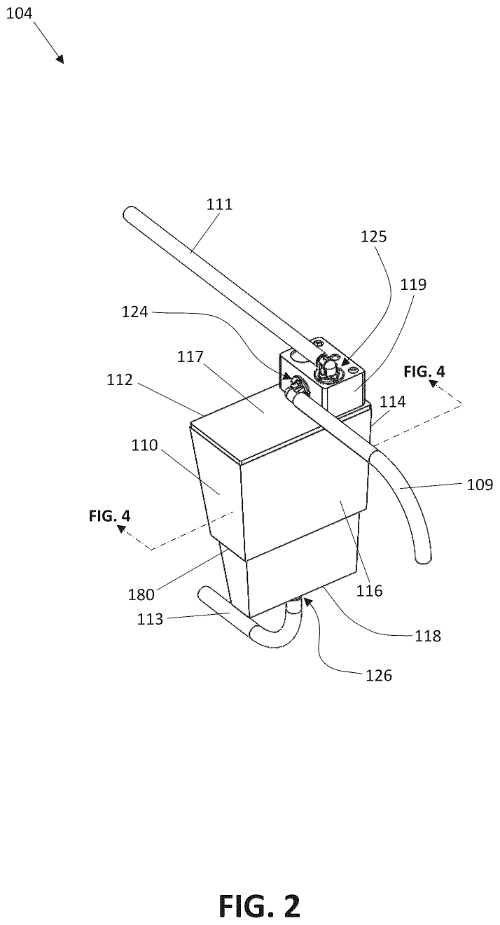

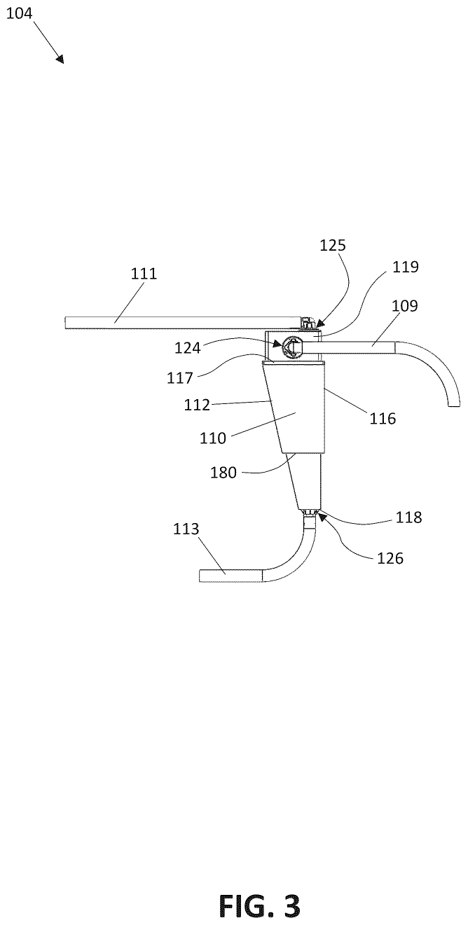

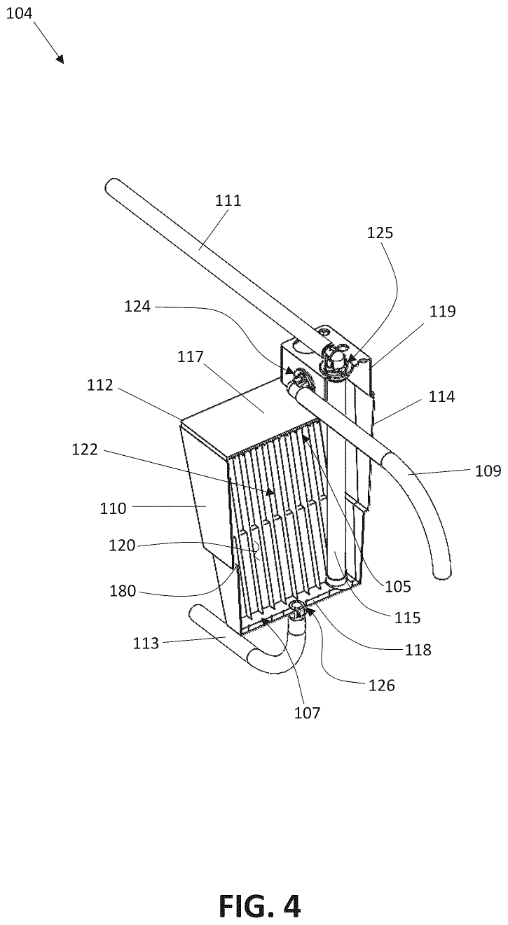

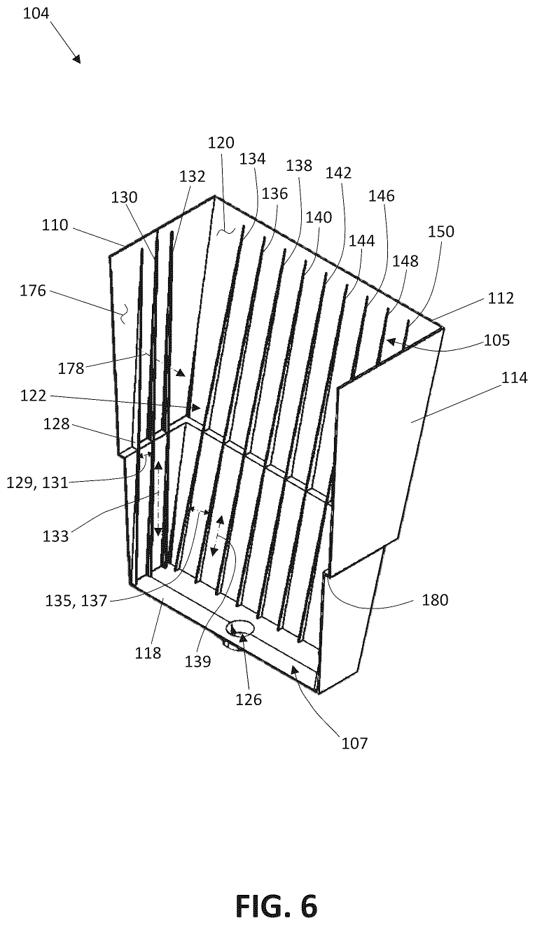

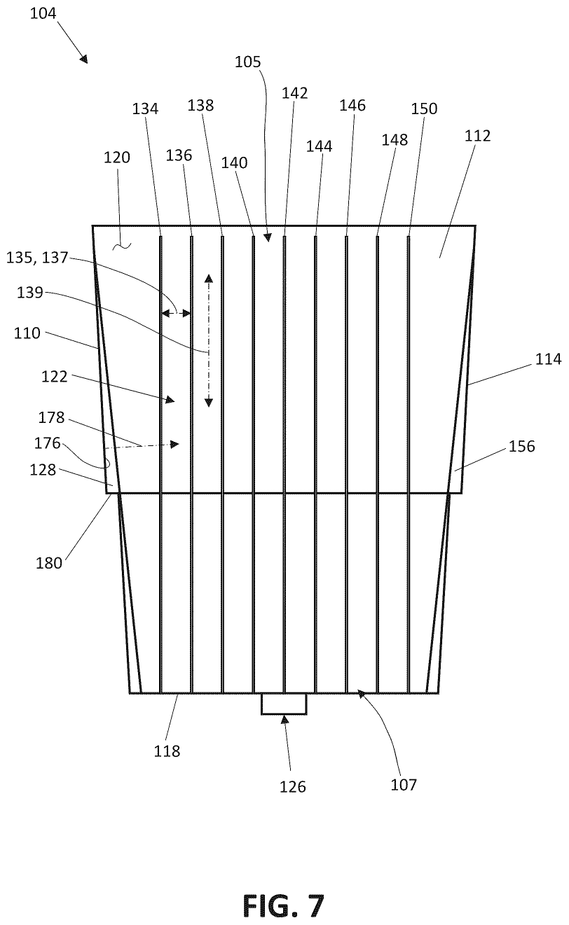

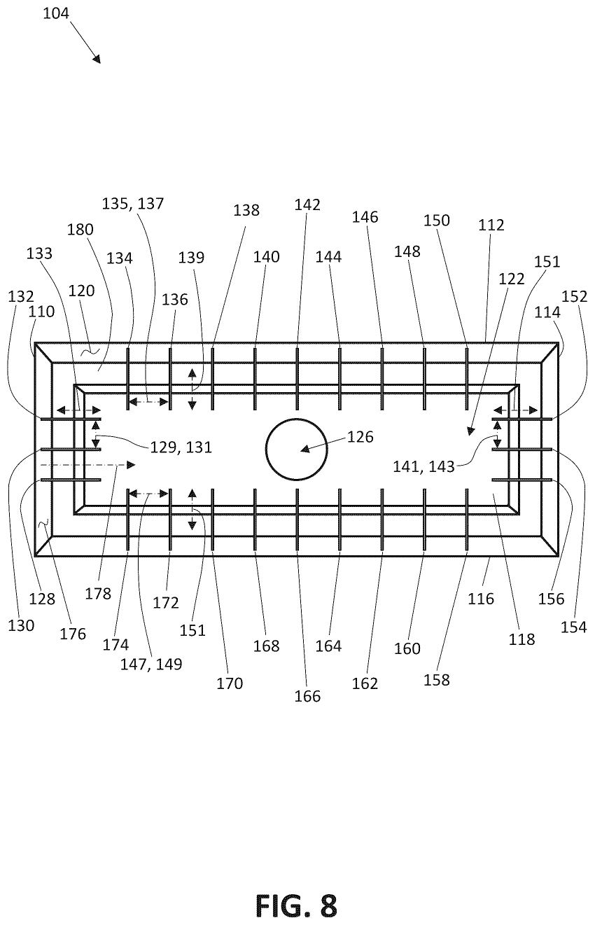

Referring now to FIGS. 2 to 8, a specific embodiment of the waste container 104 is shown and includes side walls 110, 112, 114, and 116, a top wall 117, and a bottom wall 118. In the embodiment shown, the top wall 117 includes a tower extension 119 extending from the top wall 117. In some embodiments, the top wall 117, including the tower extension 119, may be removable from the side walls 110, 112, 114, 116 and the bottom wall 118. That is, the top wall 117 may function as a cover or lid for the container 104. Collectively, the side walls 110, 112, 114, 116, the top wall 117, and the bottom wall 118 form an inner surface 120 of the waste container 104. The inner surface 120 defines a chamber shown generally at 122, which may hold waste produced onboard the watercraft 102. The tower extension 119 of the top wall 117 defines a top inlet, shown generally at 124, for receiving waste into the chamber 122, and a top outlet, shown generally at 125, for removing waste from the chamber 122. The bottom wall 118 defines a bottom outlet, shown generally at 126, for removing waste from the chamber 122.

The top inlet 124 is generally configured to be in fluid communication with a toilet and/or a sink (not shown) onboard the watercraft 102 when the waste container 104 is installed on the watercraft 102 as shown in FIG. 1. In the embodiment shown (see FIGS. 2 to 4), the top inlet 124 is in fluid communication with the toilet and/or a sink via an inlet pipe 109. The top outlet 125 is generally configured to be in fluid communication with a pump-out fitting (not shown) of the watercraft 102 when the waste container 104 is installed on the watercraft 102. In the embodiment shown, the top outlet 125 is in fluid communication with the pump-out fitting via an outlet pipe 111. The bottom outlet 126 is generally configured to be in fluid communication with a seacock (not shown) on the hull 106 of the watercraft 102 when the waste container 104 is installed on the watercraft 102. In the embodiment shown, the bottom outlet 126 is in fluid communication with the seacock via an outlet pipe 113. Thus, when the waste container 104 is installed on the watercraft 102, the top inlet 124 may receive waste from the toilet and/or sink via the inlet pipe 109, and waste may be removed from the waste container 104 through the top outlet 125 and out the pump-out fitting via the outlet pipe 111, and/or through the bottom outlet 126 and out the seacock via the outlet pipe 113. For example, waste may be removed through the top outlet 125 and out the pump-out fitting when the watercraft 102 is in port, while waste may be removed through the bottom outlet 126 and out the seacock when the watercraft 102 is in open waters.

In the embodiment shown, when the waste container 104 is installed on the watercraft 102 as shown in FIG. 1, the waste container 104 is oriented such that the top wall 117 (including the tower extensions 119) is generally a vertically uppermost, or top, boundary of the waste container 104, and the bottom wall 118 is generally a vertically lowermost, or bottom, boundary of the waste container 104—i.e., such that the top wall 117 generally faces a top of the watercraft 102 and the bottom wall 118 generally faces a bottom of the watercraft 102. As such, in the embodiment shown, when the waste container 104 is installed on the watercraft 102 as shown in FIG. 1, the top inlet 124 and the top outlet 125 are generally at a top 105 of the chamber 122, and the bottom outlet 126 is generally at a bottom 107 of the chamber 122. Due to the position of the bottom outlet 126 at the bottom 107 of the chamber 122, emptying of waste from the chamber 122 through the bottom outlet 126 may be assisted by gravity. In the embodiment shown, the waste container 104 also includes a dip tube 115 extending from the top outlet 125 into the chamber 122, terminating at the bottom 107 of the chamber 122 near the bottom wall 118. The dip tube 115 is in fluid communication with both the top outlet 125 and the chamber 122, and thus provides a conduit for waste to pass directly from the bottom 107 of the chamber 122 out the top outlet 125, for example when vacuum suction is applied to the pump-out fitting.

In some embodiments, one or more of the top inlet 124, the top outlet 125, and the bottom outlet 126 may be reversibly closable. For example, in some embodiments, the waste container 104 may include one or more valves (not shown) operable to reversibly close the top inlet 124, the top outlet 125, and/or the bottom outlet 126. The one or more valves may be, for example, ball valves.

The waste container 104 of the embodiment shown in FIGS. 2 to 8 is an example only, and alternative embodiments may differ. For example, alternative embodiments may include a waste container with a different shape and/or having a different number of walls. In some alternative embodiments, the waste container may have only a single wall (e.g., a generally spherically-shaped waste container). In other alternative embodiments, the waste container may include a plurality of walls where at least some of the walls are parallel with each other (e.g., a generally rectangular cuboid-shaped waste container).

In the embodiment shown in FIGS. 2 to 8, the waste container 104 includes three openings in the chamber 122 for conveying waste into and out of the chamber 122: the top inlet 124, the top outlet 125, and the bottom outlet 126. However, in alternative embodiments, the waste container 104 may include only a single opening in the chamber 122, or may include two openings or four or more openings in the chamber 122. For example, in some alternative embodiments, the waste container 104 may include multiple inlets.

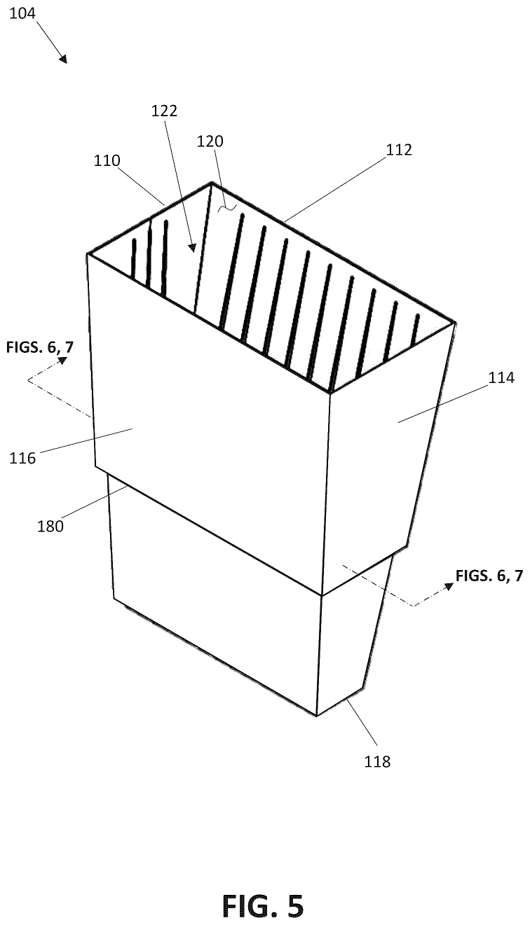

FIGS. 5 to 8 show the waste container 104 with the inlet pipe 109, the outlet pipes 111 and 113, the top wall 117, and the dip tube 115 removed. Referring to FIGS. 5 to 8, the waste container 104 also includes projections 128, 130, and 132 projecting into the chamber 122 from the inner surface 120 at the side wall 110; projections 134, 136, 138, 140, 142, 144, 146, 148, and 150 projecting into the chamber 122 from the inner surface 120 at the side wall 112; projections 152, 154, and 156 projecting into the chamber 122 from the inner surface 120 at the side wall 114; and projections 158, 160, 162, 164, 166, 168, 170, 172, and 174 projecting into the chamber 122 from the inner surface 120 at the side wall 116. The projections 128, 130, 132, 134, 136, 138, 140, 142, 144, 146, 148, 150, 152, 154, 156, 158, 160, 162, 164, 166, 168, 170, 172, and 174 may also be referred to as “paddles”, “ribs”, or “paddle ribs”.

In the embodiment shown, each of the projections 128, 130, 132, 134, 136, 138, 140, 142, 144, 146, 148, 150, 152, 154, 156, 158, 160, 162, 164, 166, 168, 170, 172, and 174 projects into the chamber 122 from a respective portion of the inner surface 120 in a respective projection direction that is generally orthogonal to the respective portion of the inner surface 120. For example, the projections 128, 130, and 132 project from a portion 176 of the inner surface 120 at the side wall 110 in a direction 178 that is generally orthogonal to the portion 176 of the inner surface 120.

The projections 128, 130, 132, 134, 136, 138, 140, 142, 144, 146, 148, 150, 152, 154, 156, 158, 160, 162, 164, 166, 168, 170, 172, and 174 may each project to varying depths into the chamber 122 from the inner surface 120. In some embodiments, at least a portion of each of the projections 128, 130, 132, 134, 136, 138, 140, 142, 144, 146, 148, 150, 152, 154, 156, 158, 160, 162, 164, 166, 168, 170, 172, and 174 may project about 0.5 inches, at least 0.5inches, about 1.25 inches, or at least 1.25 inches into the chamber 122 from the inner surface 120. In some embodiments, an entirety of each of the projections 128, 130, 132, 134, 136, 138, 140, 142, 144, 146, 148, 150, 152, 154, 156, 158, 160, 162, 164, 166, 168, 170, 172, and 174 may project about 0.5 inches, at least 0.5 inches, about 1.25 inches, or at least 1.25 inches into the chamber 122 from the inner surface 120. In some embodiments, each of the projections 128, 130, 132, 134, 136, 138, 140, 142, 144, 146, 148, 150, 152, 154, 156, 158, 160, 162, 164, 166, 168, 170, 172, and 174 may project no more than 0.5 inches or 1.25 inches into the chamber 122 from the inner surface 120.

In the embodiment shown, each of the projections 128, 130, 132, 134, 136, 138, 140, 142, 144, 146, 148, 150, 152, 154, 156, 158, 160, 162, 164, 166, 168, 170, 172, and 174 extends along a portion of the inner surface 120 that is between the top inlet 124 and the bottom outlet 126. More specifically, each of the projections 128, 130, 132, 134, 136, 138, 140, 142, 144, 146, 148, 150, 152, 154, 156, 158, 160, 162, 164, 166, 168, 170, 172, and 174 generally extends in a direction from the top inlet 124 towards the bottom outlet 126. Thus, when the waste container 104 is installed on the watercraft 102, each of the projections 128, 130, 132, 134, 136, 138, 140, 142, 144, 146, 148, 150, 152, 154, 156, 158, 160, 162, 164, 166, 168, 170, 172, and 174 extends along the inner surface 120 in a substantially vertical direction, generally from the top 105 to the bottom 107 of the chamber 122.

In addition, in the embodiment shown, each of the projections 128, 130, 132, 134, 136, 138, 140, 142, 144, 146, 148, 150, 152, 154, 156, 158, 160, 162, 164, 166, 168, 170, 172, and 174 extends along the inner surface 120 without contacting any other one of the projections 128, 130, 132, 134, 136, 138, 140, 142, 144, 146, 148, 150, 152, 154, 156, 158, 160, 162, 164, 166, 168, 170, 172, and 174. More specifically, in the embodiment shown, the projections on each of the side walls 110, 112, 114, and 116 are oriented parallel to one another and are spaced apart from one another at respective fixed projection spacings, each of the respective fixed projection spacings being in a spacing direction along the inner surface 120 perpendicular to a respective extension direction along the inner surface 120 of the corresponding projections. That is, the projections 128, 130, and 132 extend parallel to one another along the inner surface 120 at the side wall 110 and are spaced apart from each other at a fixed projection spacing 129 in a spacing direction 131 which is perpendicular to an extension direction 133 of the projections 128, 130, and 132; the projections 134, 136, 138, 140, 142, 144, 146, 148, and 150 extend parallel to one another along the inner surface 120 at the side wall 112 and are spaced apart from each other at a fixed projection spacing 135 in a spacing direction 137 which is perpendicular to an extension direction 139 of the projections 134, 136, 138, 140, 142, 144, 146, 148, and 150; the projections 152, 154, and 156 extend parallel to one another along the inner surface 120 at the side wall 114 and are spaced apart from each other at a fixed projection spacing 141 in a spacing direction 143 which is perpendicular to an extension direction 145 of the projections 152, 154, and 156; and the projections 158, 160, 162, 164, 166, 168, 170, 172, and 174 extend parallel to one another along the inner surface 120 at the side wall 116 and are spaced apart from each other at a fixed projection spacing 147 in a spacing direction 149 which is perpendicular to an extension direction 151 of the projections 158, 160, 162, 164, 166, 168, 170, 172, and 174. In the embodiment shown, the fixed projection spacings 129 and 141 are substantially equal to one another, and the fixed projection spacings 135 and 147 are substantially equal to one another. However, in some alternative embodiments, projections along each side wall may generally have the same fixed projection spacing, while in other alternative embodiments, projections along each side wall may have unique respective fixed projection spacings. Each of the fixed projection spacings 129, 135, 141, and 147 may be, for example, at most 1 inch, about 1 inch, at least one inch, at most 2 inches, or about 2 inches.

More generally, the embodiment shown is an example only, and alternative embodiments may differ. For example, alternative embodiments may include more or fewer projections than the embodiment shown in FIGS. 2 to 8. In some alternative embodiments, the projections may project from the inner surface 120 in projection directions not necessarily orthogonal to the inner surface 120. In some alternative embodiments, the projections may not extend in directions generally from the top inlet 124 to the bottom outlet 126, but may instead extend in other directions. Moreover, in some alternative embodiments, projections along a given side wall of the waste container 104 may not all be parallel to each other, and in some embodiments, none of the projections along a given side wall may be parallel to any of the other projections along that side wall. Additionally, although in the embodiment shown in FIGS. 2 to 8 projections project from each of the side walls 110, 112, 114, and 116 while no projections project from the top wall 117 or the bottom wall 118, in alternative embodiments, projections may project from all walls of the waste container 104, while in other alternative embodiments, projections may only project from a single wall of the waste container 104, for example.

In the embodiment shown, the side walls 110, 112, 114, and 116 of the waste container 104 also define a step-back 180 between the top wall 117 and the bottom wall 118. The step-back 180 may provide structural support to the waste container 104, and may also be used to help secure the waste container 104 when the waste container 104 is installed on the watercraft 102, for example, by providing a location for securing a hold-down strap. In some embodiments, the projections 128, 130, 132, 134, 136, 138, 140, 142, 144, 146, 148, 150, 152, 154, 156, 158, 160, 162, 164, 166, 168, 170, 172, and 174 may also provide structural support to the waste container 104.

In operation, when the watercraft 102 moves, for example tilting due to engine thrust force generated by the inboard engine 108 and/or due to wave action on the hull 106, such movement/tilting of the watercraft 102 may cause movement of the waste in the chamber 122. As the waste moves in the chamber 122, the projections 128, 130, 132, 134, 136, 138, 140, 142, 144, 146, 148, 150, 152, 154, 156, 158, 160, 162, 164, 166, 168, 170, 172, and 174 may disturb or obstruct flow of the waste in the chamber 122. In some embodiments, the projections 128, 130, 132, 134, 136, 138, 140, 142, 144, 146, 148, 150, 152, 154, 156, 158, 160, 162, 164, 166, 168, 170, 172, and 174 may generate turbulence in the waste as the waste moves in the chamber 122. The turbulence thus generated may help break apart solids in the waste and disperse particles in the waste. In this way, the projections 128, 130, 132, 134, 136, 138, 140, 142, 144, 146, 148, 150, 152, 154, 156, 158, 160, 162, 164, 166, 168, 170, 172, and 174 may accelerate waste break-down in the waste container 104, and may thus enhance waste management onboard the watercraft 102.

Generally, the waste container 104 may be manufactured by molding the side walls 110, 112, 114, 116, the top wall 117, and the bottom wall 118 from resin. For example, the side walls 110, 112, 114, 116, the top wall 117, and the bottom wall 118 may be molded using a rotational molding process and/or an injection molding process. The side walls 110, 112, 114, 116 and the bottom wall 118 may be molded separately from the top wall 117 (for example, in embodiments where the top wall 117 is removable). In some embodiments, the projections 128, 130, 132, 134, 136, 138, 140, 142, 144, 146, 148, 150, 152, 154, 156, 158, 160, 162, 164, 166, 168, 170, 172, and 174 may be molded in with the side walls 110, 112, 114, 116. In other embodiments, the projections 128, 130, 132, 134, 136, 138, 140, 142, 144, 146, 148, 150, 152, 154, 156, 158, 160, 162, 164, 166, 168, 170, 172, and 174 may be fixed or attached to the inner surface 120 at the side walls 110, 112, 114, 116 after the side walls 110, 112, 114, 116 have been formed.

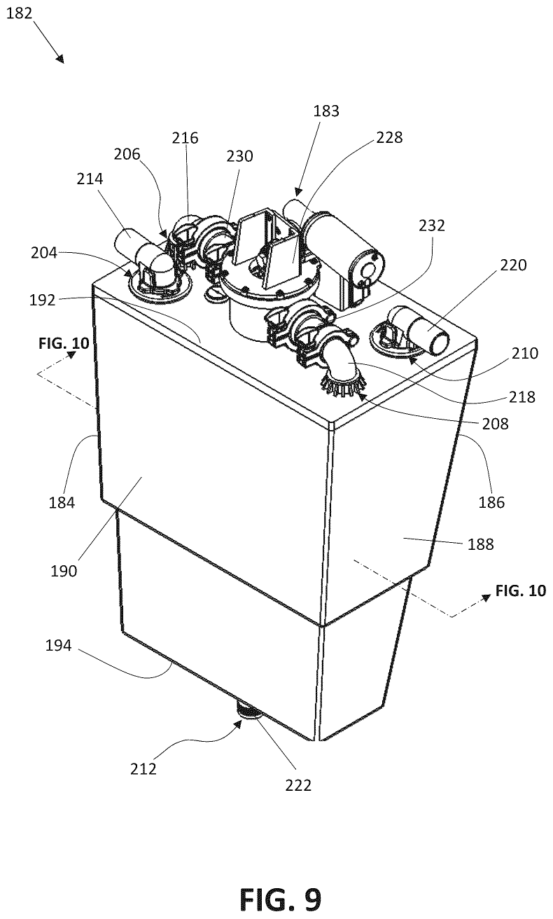

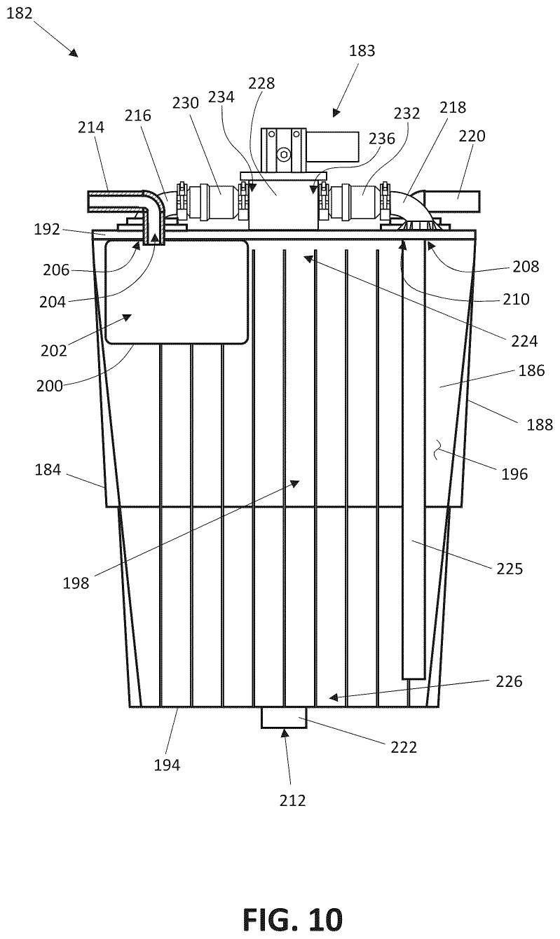

Referring now to FIGS. 9 and 10, an alternative embodiment which may be used, for example, with the vehicle waste management system 100 is shown and includes a waste container 182 and a vacuum pump system 183. The waste container 182 may be similar to the waste container 104 of the embodiment of FIGS. 2 to 8, and may be used instead of the waste container 104 onboard the watercraft 102. The waste container 182 includes side walls 184, 186, 188, and 190, a top wall 192, and a bottom wall 194. In some embodiments, the top wall 192 may be removable from the side walls 184, 186, 188, and 190 and the bottom wall 194. That is, the top wall 192 may function as a cover or lid for the container 182. Collectively, the side walls 184, 186, 188, and 190, the top wall 192, and the bottom wall 194 form an inner surface 196 of the waste container 182. The inner surface 196 defines a main chamber shown generally at 198, which may hold waste produced onboard the watercraft 102. Inside the main chamber 198, below the top wall 192, the waste container 182 includes a vacuum reservoir 200 defining a separate vacuum chamber shown generally at 202. The vacuum reservoir 200 and the top wall 192 of the waste container 182 define a top vacuum chamber inlet, shown generally at 204, for receiving waste into the vacuum chamber 202, and a top vacuum chamber outlet, shown generally at 206, for removing waste from the vacuum chamber 202. The top wall 192 also defines a top inlet shown generally at 208, for receiving waste into the chamber 198, and a top outlet, shown generally at 210, for removing waste from the chamber 198. Additionally, the bottom wall 194 defines a bottom outlet, shown generally at 212, for removing waste from the main chamber 198.

The top vacuum chamber inlet 204 is generally configured to be in fluid communication with a toilet and/or a sink (not shown) onboard the watercraft 102 when the waste container 182 is installed on the watercraft 102 as shown in FIG. 1. In the embodiment shown, the top vacuum chamber inlet 204 is in fluid communication with the toilet and/or a sink via an inlet pipe 214. The top vacuum chamber outlet 206 of the vacuum chamber 202 and the top inlet 208 of the main chamber 198 of the waste container 182 are generally configured to be in fluid communication with the vacuum pump system 183. In the embodiment shown, the top vacuum chamber outlet 206 is in fluid communication with the vacuum pump system 183 via a pump system inlet fitting 216 of the waste container 182, and the top inlet 208 is in fluid communication with the vacuum pump system 183 via a pump system outlet fitting 218 of the waste container 182. The top outlet 210 of the main chamber 198 of the waste container 182 is generally configured to be in fluid communication with a pump-out fitting (not shown) of the watercraft 102 when the waste container 182 is installed on the watercraft 102. In the embodiment shown, the top outlet 210 is in fluid communication with the pump-out fitting via an outlet pipe 220. The bottom outlet 212 is generally configured to be in fluid communication with a seacock (not shown) on the hull 106 of the watercraft 102 when the waste container 182 is installed on the watercraft 102. In the embodiment shown, the bottom outlet 212 is in fluid communication with the seacock via an outlet pipe 222. Thus, when the waste container 182 and the vacuum pump system 183 are installed on the watercraft 102, the top vacuum chamber inlet 204 may receive waste, via the inlet pipe 214, from the toilet and/or sink into the vacuum chamber 202, the waste may be transferred from the vacuum chamber 202 to the main chamber 198 out the through the top vacuum chamber outlet 206, the pump system inlet fitting 216, the vacuum pump system 183, the pump system outlet fitting 218, and the top inlet 208, and the waste may be removed from the main chamber 198 through the top outlet 210 and out the pump-out fitting via the outlet pipe 220, and/or through the bottom outlet 212 and out the seacock via the outlet pipe 222. For example, waste may be removed through the top outlet 210 and out the pump-out fitting when the watercraft 102 is in port, while waste may be removed through the bottom outlet 212 and out the seacock when the watercraft 102 is in open waters.

In the embodiment shown, when the waste container 182 is installed on the watercraft 102 as shown in FIG. 1, the waste container 182 is oriented such that the top wall is generally a vertically uppermost, or top, boundary of the waste container 182, and the bottom wall 194 is generally a vertically lowermost, or bottom, boundary of the waste container 182—i.e., such that the top wall 192 generally faces a top of the watercraft 102 and the bottom wall 194 generally faces a bottom of the watercraft 102. As such, in the embodiment shown, when the waste container 182 is installed on the watercraft 102 as shown in FIG. 1, the top vacuum chamber inlet 204 and the top outlet 210 are generally at a top 224 of the main chamber 198 (and of the vacuum chamber 202), and the bottom outlet 212 is generally at a bottom 226 of the main chamber 198. Due to the position of the bottom outlet 212 at the bottom 226 of the main chamber 198, emptying of waste from the main chamber 198 through the bottom outlet 212 may be assisted by gravity. In the embodiment shown, the waste container 182 also includes a dip tube 225 extending from the top outlet 210 into the chamber 182, terminating at the bottom 226 of the chamber 182 near the bottom wall 194. The dip tube 225 is in fluid communication with both the top outlet 210 and the chamber 182, and thus provides a conduit for waste to pass directly from the bottom 226 of the chamber 182 out the top outlet 210, for example when vacuum suction is applied to the pump-out fitting.

In some embodiments, one or more of the top vacuum chamber inlet 204, the top outlet 210, and the bottom outlet 212 may be reversibly closable. For example, in some embodiments, the waste container 182 may include one or more valves (not shown) operable to reversibly close the top vacuum chamber inlet 204, the top outlet 210, and/or the bottom outlet 212. The one or more valves may be, for example, ball valves.

The waste container 182 of the embodiment shown in FIGS. 9 and 10 is an example only, and alternative embodiments may differ. For example, alternative embodiments may include a waste container with a different shape and/or having a different number of walls. In some alternative embodiments, the waste container may have only a single wall (e.g., a generally spherically-shaped waste container). In other alternative embodiments, the waste container may include a plurality of walls where at least some of the walls are parallel with each other (e.g., a generally rectangular cuboid-shaped waste container).

In the embodiment shown in FIGS. 9 and 10, the waste container 182 includes five openings: two in the vacuum chamber 202 for conveying waste into and out of the vacuum chamber 202-the top vacuum chamber inlet 204 and the top vacuum chamber outlet 206; and three in the main chamber 198 for conveying waste into and out of the main chamber 198—the top inlet 208, the top outlet 210, and the bottom outlet 212. However, in alternative embodiments, the waste container 182 may include different numbers of openings in the vacuum chamber 202 and/or in the main chamber 198. For example, in some alternative embodiments, the waste container 182 may include multiple vacuum chamber inlets.

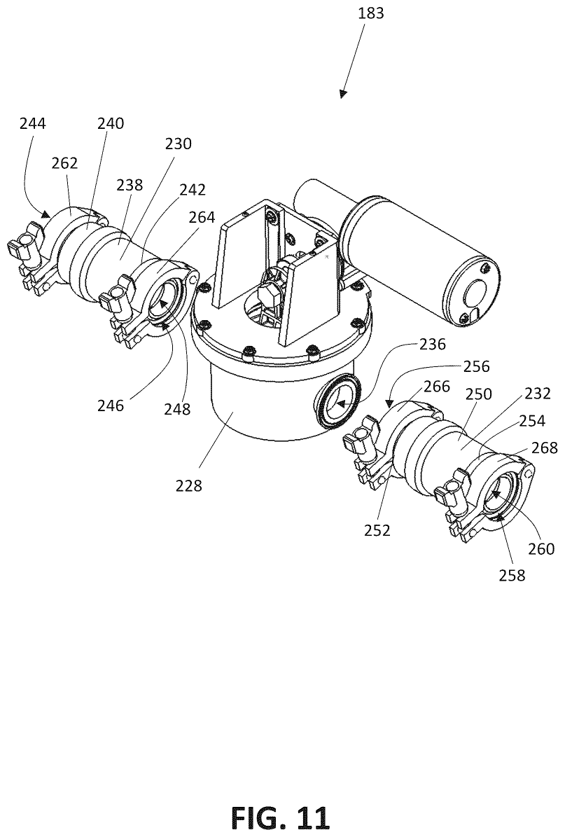

Referring now to FIGS. 9, 10, and 11, the vacuum pump system 183 includes a vacuum pump 228, an upstream valve apparatus 230, and a downstream valve apparatus 232. Generally, the vacuum pump system 183 is configured to control a flow of waste and/or other fluids from the vacuum chamber 202 to the main chamber 198. More specifically, the vacuum pump 228 is operable to cause the waste and/or other fluids to flow through the pump system 183, while the upstream valve apparatus 230 and the downstream valve apparatus 232 control the direction of flow. The vacuum pump 228 includes a pump inlet, shown generally at 234 (see FIG. 10), for receiving the waste into the vacuum pump 228, and a pump outlet, shown generally at 236, for removing the waste from the vacuum pump 228. Of course, the vacuum pump system 183 is an example only, and alternative embodiments may differ. For example, some alternative embodiments may employ pumps other than vacuum pumps.

The upstream valve apparatus 230 is generally similar to the downstream valve apparatus 232, and each of the valve apparatuses 230 and 232 may generally be configured for use with a pump, such as the vacuum pump 228, to control a flow of waste into or out of a waste container, such as the waste container 182 or the vacuum reservoir 200. The upstream valve apparatus 230 includes a valve body 238 having an inlet end 240 and an outlet end 242. The inlet end 240 defines a channel inlet, shown generally at 244, and the outlet end 242 defines a channel outlet, shown generally at 246. Between the channel inlet 244 and the channel outlet 246, the valve body 238 defines a flow channel, shown generally at 248, for conveying waste. That is, the flow channel 248 includes and extends between the channel inlet 244 and the channel outlet 246. Similarly, the downstream valve apparatus 232 includes a valve body 250 having an inlet end 252 and an outlet end 254. The inlet end 252 defines a channel inlet, shown generally at 256, and the outlet end 254 defines a channel outlet, shown generally at 258. Between the channel inlet 256 and the channel outlet 258, the valve body 250 defines a flow channel, shown generally at 260, for conveying waste. That is, the flow channel 260 includes and extends between the channel inlet 256 and the channel outlet 258.

Generally, each of the inlet ends 240 and 252 is connectable to a waste source to cause the respective flow channel 248 or 260 to be in fluid communication with the waste source through the respective channel inlet 244 or 256, such that the respective channel inlet 244 or 256 may receive waste into the respective flow channel 248 or 260. Similarly, each of the outlet ends 242 and 254 is connectable to a waste destination to cause the respective flow channel 248 or 260 to be in fluid communication with the waste destination through the respective channel outlet 246 or 258, such that the respective channel outlet 246 or 258 may remove waste from the respective flow channel 248 or 260. The waste source may be, for example, a waste container such as the waste container 104, the waste container 182, or the vacuum reservoir 200; or a pump such as the vacuum pump 228. Similarly, the waste destination may be, for example, a waste container such as the waste container 104, the waste container 182, or the vacuum reservoir 200; or a pump such as the vacuum pump 228.

In the embodiment shown, the inlet end 240 of the upstream valve apparatus 230 is connected to the pump system inlet fitting 216 and thus the vacuum reservoir 200 and, more generally, the waste container 182, causing the flow channel 248 to be in fluid communication with the vacuum reservoir 200 (i.e., the waste source of the upstream valve apparatus 230) through the channel inlet 244. The outlet end 242 of the upstream valve apparatus 230 is connected to the pump inlet 234, causing the flow channel 248 to be in fluid communication with the vacuum pump 228 (i.e., the waste destination of the upstream valve apparatus 230) through the channel outlet 246. The inlet end 252 of the downstream valve apparatus 232 is connected to the pump outlet 236, causing the flow channel 260 to be in fluid communication with the vacuum pump 228 (i.e., the waste source of the downstream valve apparatus 232) through the channel inlet 256. The outlet end 254 of the downstream valve apparatus 232 is connected to the pump system outlet fitting 218 and thus the waste container 182, causing the flow channel 260 to be in fluid communication with the waste container 182 (i.e., the waste destination of the downstream valve apparatus 232) through the channel outlet 258. However, the embodiment shown is an example only, and alternative embodiments may differ. For example, in some alternative embodiments, the inlet end 240 of the upstream valve apparatus 230 and/or the outlet end 254 of the downstream valve apparatus 232 may be connected directly to the waste container 182 (i.e., as opposed to connecting through the pump system inlet fitting 216 or the pump system outlet fitting 218).

Each of the valve apparatuses 230 and 232 also includes a pair of clamps for releasably securing the valve apparatuses 230 and 232 to their respective waste sources and/or waste destinations. More specifically, the upstream valve apparatus 230 includes a channel inlet clamp 262 operable to releasably secure the inlet end 240 of the upstream valve apparatus 230 to a waste source of the upstream valve apparatus 230 to connect the inlet end 240 to the waste source to cause the flow channel 248 to be in fluid communication with the waste source through the channel inlet 244, and a channel outlet clamp 264 operable to releasably secure the outlet end 242 of the upstream valve apparatus 230 to a waste destination of the upstream valve apparatus 230 to connect the outlet end 242 to the waste destination to cause the flow channel 248 to be in fluid communication with the waste destination through the channel outlet 246. Similarly, the downstream valve apparatus 232 includes a channel inlet clamp 266 operable to releasably secure the inlet end 252 of the downstream valve apparatus 232 to a waste source of the downstream valve apparatus 232 to connect the inlet end 252 to the waste source to cause the flow channel 260 to be in fluid communication with the waste source through the channel inlet 256, and a channel outlet clamp 268 operable to releasably secure the outlet end 254 of the downstream valve apparatus 232 to a waste destination of the downstream valve apparatus 232 to connect the outlet end 254 to the waste destination to cause the flow channel 260 to be in fluid communication with the waste destination through the channel outlet 258. In the embodiment shown, the channel inlet clamp 262 releasably secures and connects the inlet end 240 of the upstream valve apparatus 230 to the pump system inlet fitting 216, the channel outlet clamp 264 releasably secures and connects the outlet end 242 of the upstream valve apparatus 230 to the pump inlet 234, the channel inlet clamp 266 releasably secures and connects the inlet end 252 of the downstream valve apparatus 232 to the pump outlet 236, and the channel outlet clamp 268 releasably secures and connects the outlet end 254 of the downstream valve apparatus 232 to the pump system outlet fitting 218. Thus, the upstream valve apparatus 230 is connected and releasably secured to the pump system inlet fitting 216 and to the vacuum pump 228, and the downstream valve apparatus 232 is connected and releasably secured to the vacuum pump 228 and to the pump system outlet fitting 218.

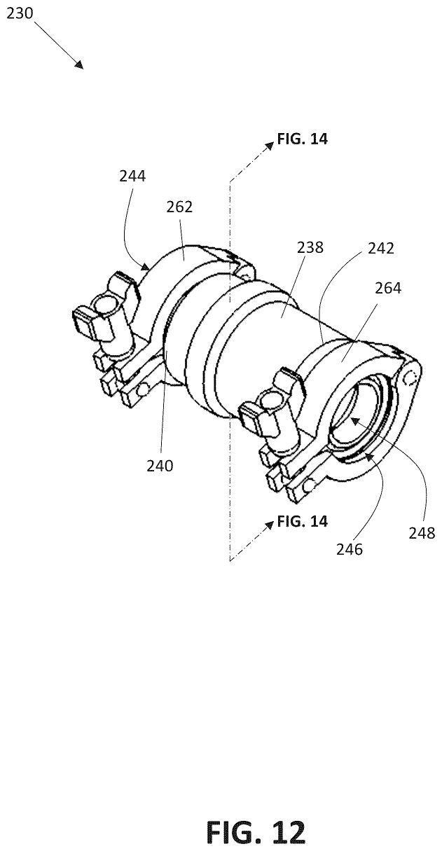

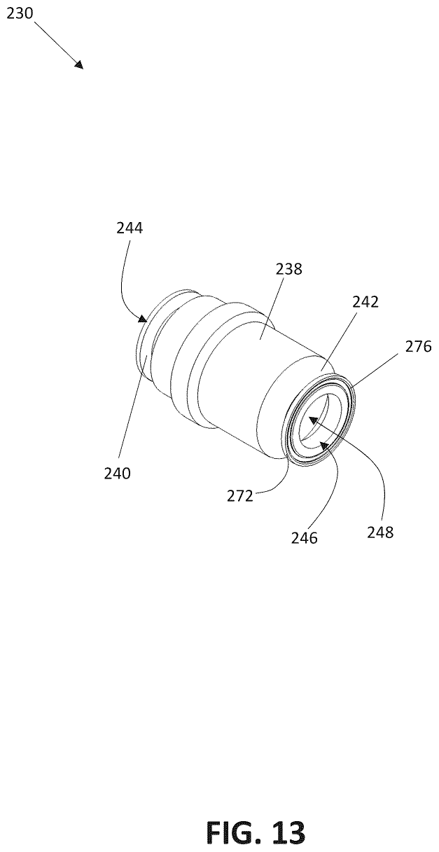

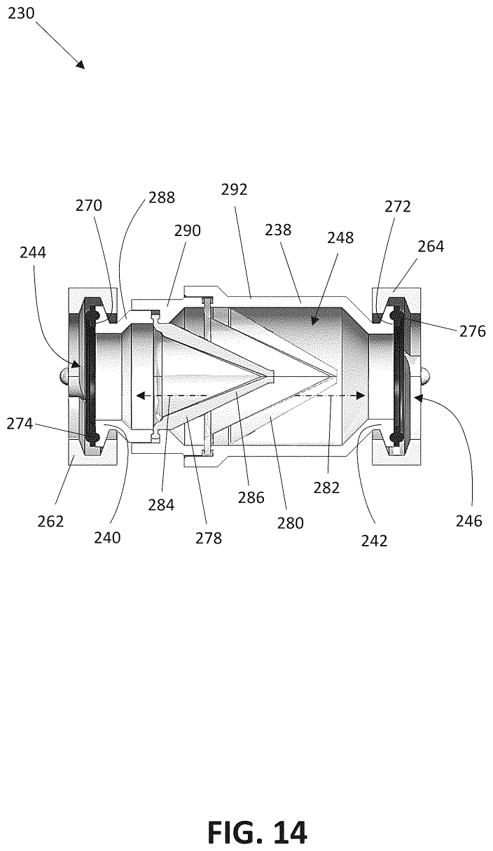

FIGS. 12, 13, and 14 show the upstream valve apparatus 230 in greater detail. However, the following explanation and references to FIGS. 12, 13, and 14 are also applicable to the downstream valve apparatus 232, which, as noted above, is generally similar to the upstream valve apparatus 230. Referring to FIGS. 12, 13, and 14, the inlet end 240 of the upstream valve apparatus 230 includes an inlet end mating surface 270 around the channel inlet 244, and the outlet end 242 of the upstream valve apparatus 230 includes an outlet end mating surface 272 around the channel outlet 246. Generally, the inlet end mating surface 270 is configured to engage with a corresponding waste source mating surface of a waste source of the upstream valve apparatus 230 when the inlet end 240 is connected to the waste source. Similarly, the outlet end mating surface 272 is configured to engage with a corresponding waste destination mating surface of a waste destination of the upstream valve apparatus 230 when the outlet end 242 is connected to the waste destination. In the embodiment shown, the inlet end mating surface 270 engages with a corresponding mating surface (not shown) of the pump system inlet fitting 216, and the outlet end mating surface 272 engages with a corresponding pump inlet mating surface (not shown) of the vacuum pump 228. However, alternative embodiments may differ. For example, in some alternative embodiments, the inlet end mating surface 270 may engage with a corresponding mating surface that is directly on the top wall 192 of the waste container 182.

The upstream valve apparatus 230 also includes a channel inlet seal 274 seated on the inlet end mating surface 270 around the channel inlet 244, and a channel outlet seal 276 seated on the outlet end mating surface 272 around the channel outlet 246. Generally, the channel inlet seal 274 is configured to seal an interface between the inlet end mating surface 270 and a corresponding waste source mating surface of a waste source of the upstream valve apparatus 230 when the inlet end mating surface 270 engages with the waste source mating surface, and the channel outlet seal 276 is configured to seal an interface between the outlet end mating surface 272 and a corresponding waste destination mating surface of a waste destination of the upstream valve apparatus 230 when the outlet end mating surface 272 engages with the waste destination mating surface. In the embodiment shown, the channel inlet seal 274 seals an interface between the inlet end mating surface 270 and the corresponding mating surface of the pump system inlet fitting 216, and the channel outlet seal 276 seals an interface between the outlet end mating surface 272 and the corresponding pump inlet mating surface of the vacuum pump 228. In the embodiment shown, each of the channel inlet seal 274 and the channel outlet seal 276 includes a face seal and an O-ring. However, the embodiment shown is an example only, and alternative embodiments may differ. For example, some alternative embodiments may include inlet/outlet seals which include only a face seal, or which include only an O-ring, or which include other types of mechanical seal.

The upstream valve apparatus 230 also includes a first check valve 278 and a second check valve 280. The first check valve 278 and the second check valve 280 are retained and secured within the flow channel 248 by the valve body 238. Each of the first check valve 278 and the second check valve 280 is configured to allow waste to flow through the flow channel 248 in a forward flow direction 282 from the channel inlet 244 to the channel outlet 246, and to prevent the waste from flowing through the flow channel 248 in a reverse flow direction 284 from the channel outlet 246 to the channel inlet 244. Thus, the upstream valve apparatus 230 is generally configured to allow waste to flow from the channel inlet 244 to the channel outlet 246 (in the forward flow direction 282), and to prevent waste from flowing from the channel outlet 246 to the channel inlet 244 (in the reverse flow direction 284). Similarly, the downstream valve apparatus 232 is generally configured to allow waste to flow from the channel inlet 252 to the channel outlet 254, and to prevent waste from flowing from the channel outlet 254 to the channel inlet 252. Consequently, when the upstream valve apparatus 230 and the downstream valve apparatus 232 are connected and releasably secured to the vacuum pump 228 as shown in FIGS. 9 and 10, such that the flow channel 248 of the upstream valve apparatus 230 is in fluid communication with the vacuum pump 228 through the pump inlet 234 and the flow channel 260 of the downstream valve apparatus 232 is in fluid communication with the vacuum pump 228 through the pump outlet 236, the upstream valve apparatus 230 generally allows waste to flow into the vacuum pump 228 though the pump inlet 234 while preventing waste from flowing out of the vacuum pump 228 though the pump inlet 234, and the downstream valve apparatus 232 generally allows waste to flow out of the vacuum pump 228 through the pump outlet 236 while preventing waste from flowing into the vacuum pump 228 though the pump outlet 236. Therefore, the upstream valve apparatus 230 and the downstream valve apparatus 232 effectively control the direction of flow of waste through the vacuum pump 228 when the vacuum pump 228 causes the waste to flow through the vacuum pump system 183, generally allowing the waste to flow in a direction from the pump inlet 234 to the pump outlet 236, and generally preventing the waste from flowing in a direction from the pump outlet 236 to the pump inlet 234. Thus, overall, when the vacuum pump 228 causes waste to flow through the vacuum pump system 183, the waste may flow through the vacuum pump system 183 by entering the upstream valve apparatus 230 (and thus the vacuum pump system 183) through the channel inlet 244, passing through the flow channel 248, leaving the upstream valve apparatus 230 through the channel outlet 246, entering the vacuum pump 228 through the pump inlet 234, passing through the vacuum pump 228, leaving the vacuum pump 228 through the pump outlet 236, entering the downstream valve apparatus 232 through the channel inlet 256, passing through the flow channel 260, and leaving the downstream valve apparatus 232 (and thus the vacuum pump system 183) through the channel outlet 258.

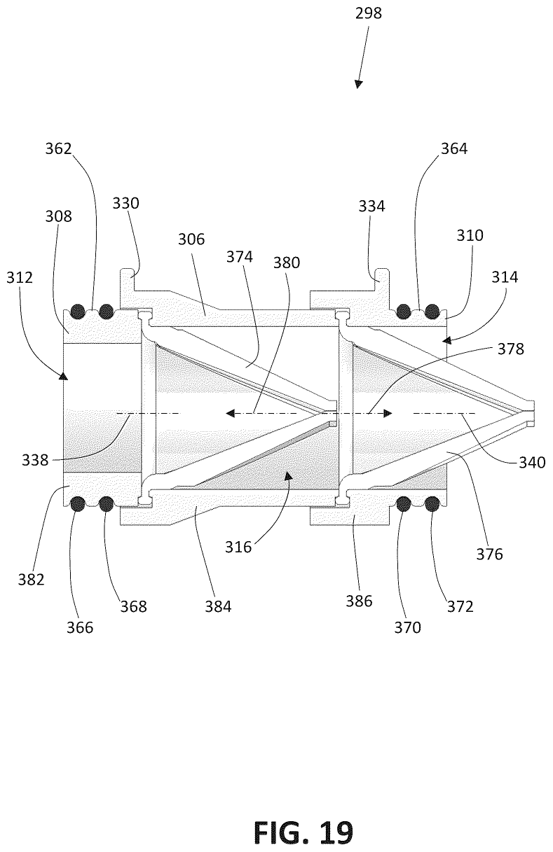

In the embodiment shown, each of the first check valve 278 and the second check valve 280 of the upstream valve apparatus 230 is a duckbill valve, and a portion 286 of the first check valve 278 is received in the second check valve 280. That is, the first check valve 278 is nested within second check valve 280. However, the embodiment shown is an example only, and alternative embodiments may differ. For example, some alternative embodiments may include other types of check valves instead of or in addition to duckbill valves. Additionally, in some alternative embodiments, the valve apparatus may include a different number of check valves in the flow channel, such as only a single check valve in the flow channel, or three or more check valves in the flow channel. Some alternative embodiments may include check valves which are not nested (see, for example, FIG. 19).

In the embodiment shown, the valve body 238 of the upstream valve apparatus 230 includes valve body portions 288, 290, and 292 arranged between the channel inlet 244 and the channel outlet 246. The valve body portions 288, 290, and 292 collectively define the flow channel 248 and retain the first and second check valves 278 and 280 in the flow channel 248. The valve body portion 288 is non-dismantlably fixed to the valve body portion 290, which is in turn non-dismantlably fixed to the valve body portion 292. That is, each of the valve body portions 288, 290, and 292 is non-dismantlably fixed to at least one other of the valve body portions 288, 290, and 292, such that the valve body 238 as a whole is non-dismantlable. The valve body portions 288, 290, and 292 may be fixed together by, for example, plastic welding and/or glue. Of course, the embodiment shown is an example only, and alternative embodiments may differ. For example, in alternative embodiments, the valve body 238 may include a different number of valve body portions non-dismantlably fixed together.

Generally, the upstream valve apparatus 230, or a similar valve apparatus such as the downstream valve apparatus 232, may be installed on to a waste source (such as the pump system inlet fitting 216 of the waste container 182) by positioning the inlet end 240 at the waste source and causing the channel inlet clamp 262 to secure the inlet end 240 to the waste source to connect the inlet end 240 to the waste source to cause the flow channel 248 to be in fluid communication with the waste source through the channel inlet 244. The upstream valve apparatus 230 may then be uninstalled from the waste source by causing the channel inlet clamp 262 to release the inlet end 240 from the waste source. Similarly, the upstream valve apparatus 230 may be installed on to a waste destination (such as the pump inlet 234 of the vacuum pump 228) by positioning the outlet end 242 at the waste destination and causing the channel outlet clamp 264 to secure the outlet end 242 to the waste destination to connect the outlet end 242 to the waste destination to cause the flow channel 248 to be in fluid communication with the waste destination through the channel outlet 246. The upstream valve apparatus 230 may then be uninstalled from the waste destination by causing the channel outlet clamp 264 to release the outlet end 242 from the waste destination. That is, installation and uninstallation of the upstream valve apparatus 230, or of a similar valve apparatus such as the downstream valve apparatus 232, require only the use/operation of the channel inlet clamp 262 and/or the channel outlet clamp 264. As such, valve apparatuses such as the upstream valve apparatus 230 and the downstream valve apparatus 232 disclosed herein may simplify maintenance (e.g., valve replacement) of waste management systems such as the waste management system 100.

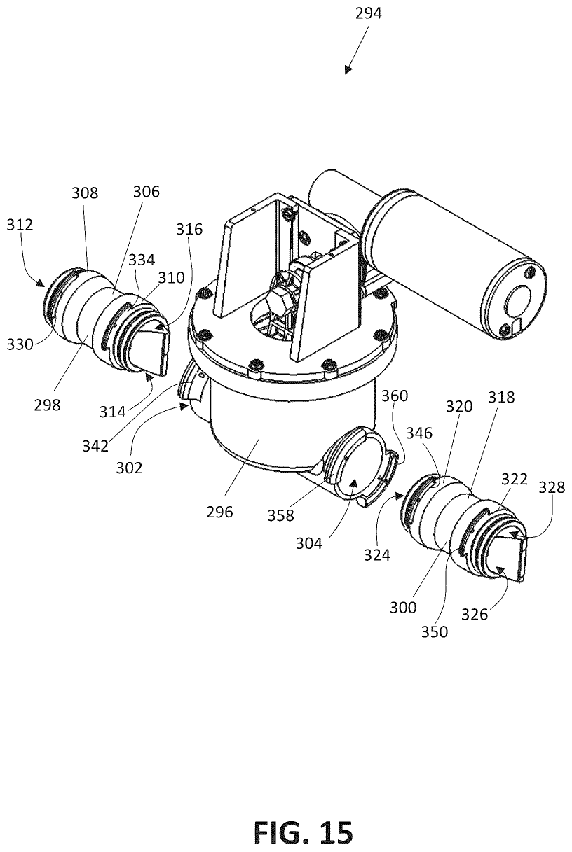

Referring now to FIGS. 15, 16, and 17, an alternative embodiment of a vacuum pump system is shown generally at 294 and includes a vacuum pump 296, an upstream valve apparatus 298, and a downstream valve apparatus 300. The vacuum pump system 294 may be used, for example, with the waste container 182 in the vehicle waste management system 100, instead of the vacuum pump system 183. That is, in embodiments where the vehicle waste management system 100 includes the vacuum pump system 294 installed with the waste container 182, the top vacuum chamber outlet 206 of the vacuum chamber 202 of the waste container 182 may be in fluid communication with the vacuum pump system 294 via the pump system inlet fitting 216, and the top inlet 208 of the main chamber 198 of the waste container 182 may be in fluid communication with the vacuum pump system 294 via the pump system outlet fitting 218 (see also FIGS. 9 and 10). Thus, when the waste container 182 and the vacuum pump system 294 are installed on the watercraft 102, the top vacuum chamber inlet 204 may receive waste, via the inlet pipe 214, from the toilet and/or sink into the vacuum chamber 202, the waste may be transferred from the vacuum chamber 202 to the main chamber 198 out the through the top vacuum chamber outlet 206, the pump system inlet fitting 216, the vacuum pump system 294, the pump system outlet fitting 218, and the top inlet 208, and the waste may be removed from the main chamber 198 through the top outlet 210 and out the pump-out fitting via the outlet pipe 220, and/or through the bottom outlet 212 and out the seacock via the outlet pipe 222. In such embodiments, the vacuum pump system 294, much like the vacuum pump system 183 of the embodiment of FIGS. 9, 10, and 11, may generally be configured to control a flow of waste and/or other fluids from the vacuum chamber 202 to the main chamber 198. More specifically, the vacuum pump 296 is operable to cause the waste and/or other fluids to flow through the pump system 294, while the upstream valve apparatus 298 and the downstream valve apparatus 300 control the direction of flow. The vacuum pump 296 may generally be similar to the vacuum pump 228, and includes a pump inlet, shown generally at 302, for receiving the waste into the vacuum pump 296, and a pump outlet, shown generally at 304, for removing the waste from the vacuum pump 296.

The upstream valve apparatus 298 is generally similar to the downstream valve apparatus 300, and each of the valve apparatuses 298 and 300 may generally be configured for use with a pump, such as the vacuum pump 296, to control a flow of waste into or out of a waste container, such as the waste container 182 or the vacuum reservoir 200. The upstream valve apparatus 298 includes a valve body 306 having an inlet end 308 and an outlet end 310. The inlet end 308 defines a channel inlet, shown generally at 312, and the outlet end 310 defines a channel outlet, shown generally at 314. Between the channel inlet 312 and the channel outlet 314, the valve body 306 defines a flow channel, shown generally at 316, for conveying waste. That is, the flow channel 316 includes and extends between the channel inlet 312 and the channel outlet 314. Similarly, the downstream valve apparatus 300 includes a valve body 318 having an inlet end 320 and an outlet end 322. The inlet end 320 defines a channel inlet, shown generally at 324, and the outlet end 322 defines a channel outlet, shown generally at 326. Between the channel inlet 324 and the channel outlet 326, the valve body 318 defines a flow channel, shown generally at 328, for conveying waste. That is, the flow channel 328 includes and extends between the channel inlet 324 and the channel outlet 326.

Generally, each of the inlet ends 308 and 320 is connectable to a waste source to cause the respective flow channel 316 or 328 to be in fluid communication with the waste source through the respective channel inlet 312 or 324, such that the respective channel inlet 312 or 324 may receive waste into the respective flow channel 316 or 328. Similarly, each of the outlet ends 310 and 322 is connectable to a waste destination to cause the respective flow channel 316 or 328 to be in fluid communication with the waste destination through the respective channel outlet 314 or 326, such that the respective channel outlet 314 or 326 may remove waste from the respective flow channel 316 or 328. The waste source may be, for example, a waste container such as the waste container 104, the waste container 182, or the vacuum reservoir 200; or a pump such as the vacuum pump 296. Similarly, the waste destination may be, for example, a waste container such as the waste container 104, the waste container 182, or the vacuum reservoir 200; or a pump such as the vacuum pump 296.

In some embodiments, the inlet end 308 of the upstream valve apparatus 298 may be connected to the pump system inlet fitting 216 and thus the vacuum reservoir 200 and, more generally, the waste container 182, causing the flow channel 316 to be in fluid communication with the vacuum reservoir 200 (i.e., the waste source of the upstream valve apparatus 298) through the channel inlet 312. The outlet end 310 of the upstream valve apparatus 298 is connected to the pump inlet 302, causing the flow channel 316 to be in fluid communication with the vacuum pump 296 (i.e., the waste destination of the upstream valve apparatus 298) through the channel outlet 314. The inlet end 320 of the downstream valve apparatus 300 is connected to the pump outlet 304, causing the flow channel 328 to be in fluid communication with the vacuum pump 296 (i.e., the waste source of the downstream valve apparatus 300) through the channel inlet 324. The outlet end 322 of the downstream valve apparatus 300 may be connected to the pump system outlet fitting 218 and thus the waste container 182, causing the flow channel 328 to be in fluid communication with the waste container 182 (i.e., the waste destination of the downstream valve apparatus 300) through the channel outlet 326. In some alternative embodiments, the inlet end 308 of the upstream valve apparatus 298 and/or the outlet end 322 of the downstream valve apparatus 300 may instead be connected directly to the waste container 182 (i.e., as opposed to connecting through the pump system inlet fitting 216 or the pump system outlet fitting 218).

Each of the valve apparatus 298 and the valve apparatus 300 also includes a pair of inlet end interlocking portions at its inlet end (i.e., 308 and 320, respectively) and a pair of outlet end interlocking portions at its outlet end (i.e., 310 and 322, respectively). In general, the inlet end interlocking portions may be used to releasably secure the valve apparatuses 298 and 300 to their respective waste sources, while the outlet end interlocking portions may be used to releasably secure the valve apparatuses 298 and 300 to their respective waste destinations.

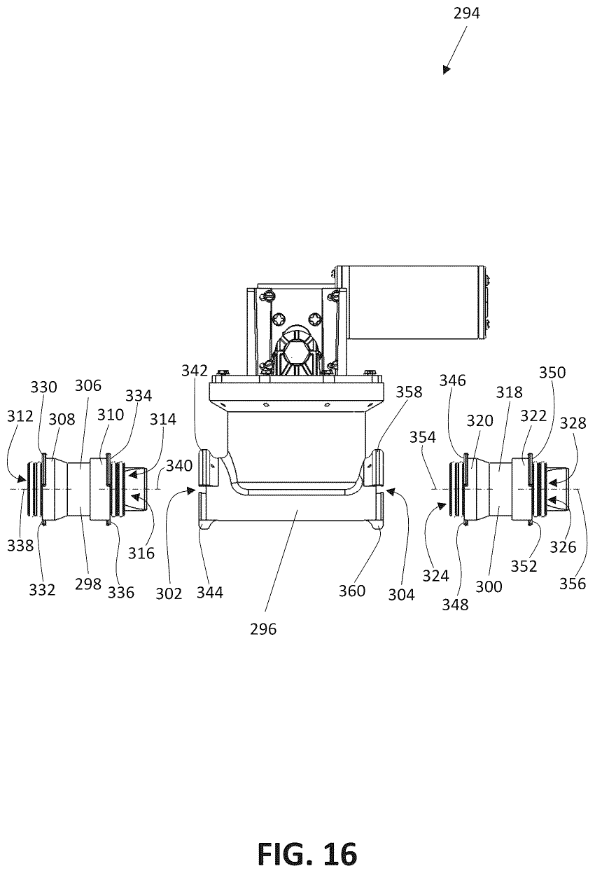

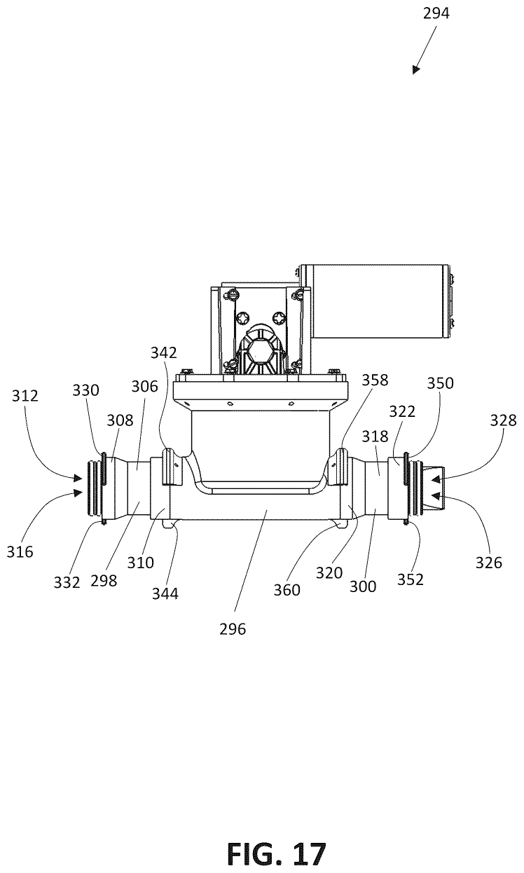

More specifically, the upstream valve apparatus 298 includes inlet end interlocking portions 330 and 332 at the inlet end 308, and outlet end interlocking portions 334 and 336 at the outlet end 310. In the embodiment shown, the inlet end interlocking portions 330 and 332 project out from the inlet end 308 of the valve body 306 away from the flow channel 316, and the outlet end interlocking portions 334 and 336 project out from the outlet end 310 of the valve body 306 away from the flow channel 316. The inlet end interlocking portions 330 and 332 are releasably interlockable with corresponding waste source interlocking portions of a waste source to releasably secure the inlet end 308 to the waste source to connect the inlet end 308 to the waste source to cause the flow channel 316 to be in fluid communication with the waste source through the channel inlet 312. The outlet end interlocking portions 334 and 336 are releasably interlockable with corresponding waste destination interlocking portions of a waste destination to releasably secure the outlet end 310 to the waste destination to connect the outlet end 310 to the waste destination to cause the flow channel 316 to be in fluid communication with the waste destination through the channel outlet 314. In the embodiment shown, the inlet end interlocking portions 330 and 332 are releasably interlockable with the corresponding waste source interlocking portions by rotation of the upstream valve apparatus 298, relative to the waste source, around an inlet channel axis 338 which is parallel to the flow channel 316 at the channel inlet 312, and the outlet end interlocking portions 334 and 336 are releasably interlockable with the corresponding waste destination interlocking portions by rotation of the upstream valve apparatus 298, relative to the waste source, around an outlet channel axis 340 which is parallel to the flow channel 316 at the channel outlet 314. For example, as shown in FIGS. 16 and 17, the vacuum pump 296—i.e., the waste destination of the upstream valve apparatus 298—includes vacuum pump inlet interlocking portions 342 and 344 projecting out from the vacuum pump 296 at the pump inlet 302. The vacuum pump inlet interlocking portions 342 and 344 are sized and shaped to slidably receive and releasably interlock with the outlet end interlocking portions 334 and 336 of the upstream valve apparatus 298 when the upstream valve apparatus 298 and the vacuum pump 296 are rotated relative to each other around the outlet channel axis 340. Thus, the outlet end 310 of the upstream valve apparatus 298 may be releasably secured and connected to the vacuum pump 296 at the pump inlet 302 by positioning the outlet end 310 at the pump inlet 302 and rotating the upstream valve apparatus 298, relative to the to the vacuum pump 296, around the outlet channel axis 340 to cause the outlet end interlocking portions 334 and 336 to slide against and releasably interlock with the vacuum pump inlet interlocking portions 342 and 344, respectively, as shown in FIG. 17. This securing mechanism based on rotational interlocking of corresponding projections on a valve apparatus and a waste source/destination may also be referred to as a “twist lock” securing mechanism.

Similarly, the downstream valve apparatus 300 includes inlet end interlocking portions 346 and 348 at the inlet end 320, and outlet end interlocking portions 350 and 352 at the outlet end 322. In the embodiment shown, the inlet end interlocking portions 346 and 348 project out from the inlet end 320 of the valve body 318 away from the flow channel 328, and the outlet end interlocking portions 350 and 352 project out from the outlet end 322 of the valve body 318 away from the flow channel 328. The inlet end interlocking portions 346 and 348 are releasably interlockable with corresponding waste source interlocking portions of a waste source to releasably secure the inlet end 320 to the waste source to connect the inlet end 320 to the waste source to cause the flow channel 328 to be in fluid communication with the waste source through the channel inlet 324. The outlet end interlocking portions 350 and 352 are releasably interlockable with corresponding waste destination interlocking portions of a waste destination to releasably secure the outlet end 322 to the waste destination to connect the outlet end 322 to the waste destination to cause the flow channel 328 to be in fluid communication with the waste destination through the channel outlet 326. In the embodiment shown, the inlet end interlocking portions 346 and 348 are releasably interlockable with the corresponding waste source interlocking portions by rotation of the downstream valve apparatus 300, relative to the waste source, around an inlet channel axis 354 which is parallel to the flow channel 328 at the channel inlet 324, and the outlet end interlocking portions 350 and 352 are releasably interlockable with the corresponding waste destination interlocking portions by rotation of the downstream valve apparatus 300, relative to the waste source, around an outlet channel axis 356 which is parallel to the flow channel 328 at the channel outlet 326. For example, as shown in FIGS. 16 and 17, the vacuum pump 296—i.e., the waste source of the downstream valve apparatus 300—includes vacuum pump outlet interlocking portions 358 and 360 projecting out from the vacuum pump 296 at the pump outlet 304. The vacuum pump outlet interlocking portions 358 and 360 are sized and shaped to slidably receive and releasably interlock with the inlet end interlocking portions 346 and 348 of the downstream valve apparatus 300 when the downstream valve apparatus 300 and the vacuum pump 296 are rotated relative to each other around the inlet channel axis 354. Thus, the inlet end 320 of the downstream valve apparatus 300 may be releasably secured and connected to the vacuum pump 296 at the pump outlet 304 by positioning the inlet end 320 at the pump outlet 304 and rotating the downstream valve apparatus 300, relative to the to the vacuum pump 296, around the inlet channel axis 354 to cause the inlet end interlocking portions 346 and 348 to slide against and releasably interlock with the vacuum pump outlet interlocking portions 358 and 360, respectively, as shown in FIG. 17.

In embodiments where the vehicle waste management system 100 includes the vacuum pump system 294 installed with the waste container 182, the inlet end interlocking portions 330 and 332 of the upstream valve apparatus 298 may be releasably interlocked with corresponding interlocking portions (not shown) on the pump system inlet fitting 216 to releasably secure and connect the inlet end 308 of the upstream valve apparatus 298 to the pump system inlet fitting 216, the outlet end interlocking portions 334 and 336 of the upstream valve apparatus 298 are releasably interlocked with the vacuum pump inlet interlocking portions 342 and 344 of the vacuum pump 296 to releasably secure and connect the outlet end 310 of the upstream valve apparatus 298 to the pump inlet 302, the inlet end interlocking portions 346 and 348 of the downstream valve apparatus 300 are releasably interlocked with the vacuum pump outlet interlocking portions 358 and 360 of the vacuum pump 296 to releasably secure and connect the inlet end 320 of the downstream valve apparatus 300 to the pump outlet 304, and the outlet end interlocking portions 350 and 352 of the downstream valve apparatus 300 may be releasably interlocked with corresponding interlocking portions (not shown) on the pump system outlet fitting 218 to releasably secure and connect the outlet end 322 of the downstream valve apparatus 300 to the pump system outlet fitting 218. Thus, the upstream valve apparatus 298 may be connected and releasably secured to the pump system inlet fitting 216 and to the vacuum pump 296, and the downstream valve apparatus 300 may be connected and releasably secured to the vacuum pump 296 and to the pump system outlet fitting 218.

Of course, the embodiment shown is an example only, and alternative embodiments may differ. For example, in the embodiment shown, the upstream and downstream valve apparatuses 298 and 300 each include two inlet end interlocking portions (i.e., 330/346 and 332/348) and two outlet end interlocking portions (i.e., 334/350 and 336/352). However, alternative embodiments may include valve apparatuses having only a single inlet end interlocking portion and/or a single outlet end interlocking portion, or valve apparatuses having more than two inlet end interlocking portions and/or more than two outlet end interlocking portions. Additionally, in some alternative embodiments, at least one of the inlet/outlet end interlocking portions may project into the flow channel of the valve apparatus, rather than away from the flow channel.

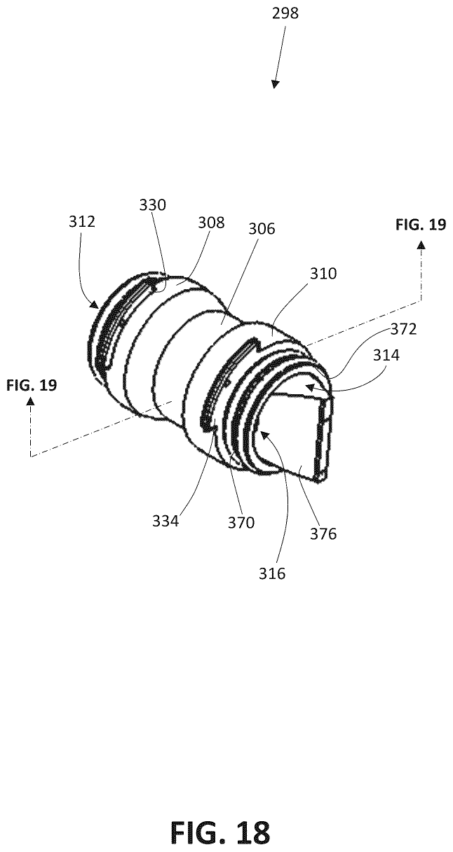

FIGS. 18 and 19 show the upstream valve apparatus 298 in greater detail. However, the following explanation and references to FIGS. 18 and 19 are also applicable to the downstream valve apparatus 300, which, as noted above, is generally similar to the upstream valve apparatus 298. Referring to FIGS. 18 and 19, the inlet end 308 of the upstream valve apparatus 298 includes an inlet end mating surface 362 around the channel inlet 312, and the outlet end 310 of the upstream valve apparatus 298 includes an outlet end mating surface 364 around the channel outlet 314. Generally, the inlet end mating surface 362 is configured to engage with a corresponding waste source mating surface of a waste source of the upstream valve apparatus 298 when the inlet end 308 is connected to the waste source. Similarly, the outlet end mating surface 364 is configured to engage with a corresponding waste destination mating surface of a waste destination of the upstream valve apparatus 298 when the outlet end 310 is connected to the waste destination. In the embodiment shown, the inlet end mating surface 362 may engage with a corresponding mating surface (not shown) of the pump system inlet fitting 216, and the outlet end mating surface 364 engages with a corresponding pump inlet mating surface (not shown) of the vacuum pump 296. However, alternative embodiments may differ. For example, in some alternative embodiments, the inlet end mating surface 362 may engage with a corresponding mating surface that is directly on the top wall 192 of the waste container 182.

The upstream valve apparatus 298 also includes channel inlet seals 366 and 368 seated on the inlet end mating surface 362 around the channel inlet 312, and a channel outlet seals 370 and 372 seated on the outlet end mating surface 364 around the channel outlet 314. Generally, the channel inlet seals 366 and 368 are configured to seal an interface between the inlet end mating surface 362 and a corresponding waste source mating surface of a waste source of the upstream valve apparatus 298 when the inlet end mating surface 362 engages with the waste source mating surface, and the channel outlet seals 370 and 372 are configured to seal an interface between the outlet end mating surface 364 and a corresponding waste destination mating surface of a waste destination of the upstream valve apparatus 298 when the outlet end mating surface 364 engages with the waste destination mating surface. In the embodiment shown, the channel inlet seals 366 and 368 may seal an interface between the inlet end mating surface 362 and the corresponding mating surface of the pump system inlet fitting 216, and the channel outlet seals 370 and 372 seal an interface between the outlet end mating surface 364 and the corresponding pump inlet mating surface of the vacuum pump 296. In the embodiment shown, each of the channel inlet seals 366 and 368 and the channel outlet seals 370 and 372 includes an O-ring. However, the embodiment shown is an example only, and alternative embodiments may differ. For example, some alternative embodiments may include inlet/outlet seals which include a face seal or another type of mechanical seal.

The upstream valve apparatus 298 also includes a first check valve 374 and a second check valve 376. The first check valve 374 and the second check valve 376 are retained and secured within the flow channel 316 by the valve body 306. Each of the first check valve 374 and the second check valve 376 is configured to allow waste to flow through the flow channel 316 in a forward flow direction 378 from the channel inlet 312 to the channel outlet 314, and to prevent the waste from flowing through the flow channel 316 in a reverse flow direction 380 from the channel outlet 314 to the channel inlet 312. Thus, the upstream valve apparatus 298 is generally configured to allow waste to flow from the channel inlet 312 to the channel outlet 314 (in the forward flow direction 378), and to prevent waste from flowing from the channel outlet 314 to the channel inlet 312 (in the reverse flow direction 380). Similarly, the downstream valve apparatus 300 is generally configured to allow waste to flow from the channel inlet 324 to the channel outlet 326, and to prevent waste from flowing from the channel outlet 326 to the channel inlet 324. Consequently, when the upstream valve apparatus 298 and the downstream valve apparatus 300 are connected and releasably secured to the vacuum pump 296 as shown in FIG. 17, such that the flow channel 316 of the upstream valve apparatus 298 is in fluid communication with the vacuum pump 296 through the pump inlet 302 and the flow channel 328 of the downstream valve apparatus 300 is in fluid communication with the vacuum pump 296 through the pump outlet 304, the upstream valve apparatus 298 generally allows waste to flow into the vacuum pump 296 though the pump inlet 302 while preventing waste from flowing out of the vacuum pump 296 though the pump inlet 302, and the downstream valve apparatus 300 generally allows waste to flow out of the vacuum pump 296 through the pump outlet 304 while preventing waste from flowing into the vacuum pump 296 though the pump outlet 304. Therefore, the upstream valve apparatus 298 and the downstream valve apparatus 300 effectively control the direction of flow of waste through the vacuum pump 296 when the vacuum pump 296 causes the waste to flow through the vacuum pump system 294, generally allowing the waste to flow in a direction from the pump inlet 302 to the pump outlet 304, and generally preventing the waste from flowing in a direction from the pump outlet 304 to the pump inlet 302. Thus, overall, when the vacuum pump 296 causes waste to flow through the vacuum pump system 294, the waste may flow through the vacuum pump system 294 by entering the upstream valve apparatus 298 (and thus the vacuum pump system 294) through the channel inlet 312, passing through the flow channel 316, leaving the upstream valve apparatus 298 through the channel outlet 314, entering the vacuum pump 296 through the pump inlet 302, passing through the vacuum pump 296, leaving the vacuum pump 296 through the pump outlet 304, entering the downstream valve apparatus 300 through the channel inlet 324, passing through the flow channel 328, and leaving the downstream valve apparatus 300 (and thus the vacuum pump system 294) through the channel outlet 326.

In the embodiment shown, each of the first check valve 374 and the second check valve 376 of the upstream valve apparatus 298 is a duckbill valve. Also, as shown in FIG. 19, the first check valve 374 and the second check valve 376 are non-overlapping in the forward flow direction 378 (and, similarly, are non-overlapping in the reverse flow direction 380). Thus, unlike the first check valve 278 and the second check valve 280 of the embodiment of FIGS. 9 to 14, the first check valve 374 and the second check valve 376 are not nested. However, the embodiment shown is an example only, and alternative embodiments may differ. For example, some alternative embodiments may include other types of check valves instead of or in addition to duckbill valves. Additionally, in some alternative embodiments, the valve apparatus may include a different number of check valves in the flow channel, such as only a single check valve in the flow channel, or three or more check valves in the flow channel.

In the embodiment shown, the valve body 306 of the upstream valve apparatus 298 includes valve body portions 382, 384, and 386 arranged between the channel inlet 312 and the channel outlet 314. The valve body portions 382, 384, and 386 collectively define the flow channel 316 and retain the first and second check valves 374 and 376 in the flow channel 316. The valve body portion 382 is non-dismantlably fixed to the valve body portion 384, which is in turn non-dismantlably fixed to the valve body portion 386. That is, each of the valve body portions 382, 384, and 386 is non-dismantlably fixed to at least one other of the valve body portions 382, 384, and 386, such that the valve body 306 as a whole is non-dismantlable. The valve body portions 382, 384, and 386 may be fixed together by, for example, plastic welding and/or glue. Of course, the embodiment shown is an example only, and alternative embodiments may differ. For example, in alternative embodiments, the valve body 306 may include a different number of valve body portions non-dismantlably fixed together.

Generally, the upstream valve apparatus 298, or a similar valve apparatus such as the downstream valve apparatus 300, may be installed on to a waste source (such as the pump system inlet fitting 216 of the waste container 182) by positioning the inlet end 308 at the waste source and rotating the upstream valve apparatus 298, relative to the to the waste source, around the inlet channel axis 338 to cause the inlet end interlocking portions 330 and 332 to slide against and releasably interlock with corresponding waste source interlocking portions of the waste source. The upstream valve apparatus 298 may then be uninstalled from the waste source by further rotating the upstream valve apparatus 298, relative to the to the waste source, around the inlet channel axis 338 to release the interlock between the inlet end interlocking portions 330 and 332 and the corresponding waste source interlocking portions. Similarly, the upstream valve apparatus 298 may be installed on to a waste destination (such as the pump inlet 302 of the vacuum pump 296) by positioning the outlet end 310 at the waste destination and rotating the upstream valve apparatus 298, relative to the to the waste destination, around the outlet channel axis 340 to cause the outlet end interlocking portions 334 and 336 to slide against and releasably interlock with corresponding waste destination interlocking portions of the waste destination. The upstream valve apparatus 298 may then be uninstalled from the waste destination by further rotating the upstream valve apparatus 298, relative to the to the waste destination, around the outlet channel axis 340 to release the interlock between the outlet end interlocking portions 334 and 336 and the corresponding waste destination interlocking portions. That is, installation and uninstallation of the upstream valve apparatus 298, or of a similar valve apparatus such as the downstream valve apparatus 300, require only the positioning and rotation of the upstream valve apparatus 298 via the twist lock securing mechanism. As such, valve apparatuses such as the upstream valve apparatus 298 and the downstream valve apparatus 300 disclosed herein may simplify maintenance (e.g., valve replacement) of waste management systems such as the waste management system 100.

Referring back to FIGS. 9, 10, 11, 15, 16, and 17, when installed on the waste container 182 (e.g., as shown in FIGS. 9 and 10), the vacuum pump system 183 or 294 is generally operable to cause waste and other fluids, including, for example, air, to flow from the vacuum chamber 202 to the main chamber 198. Thus, if the top vacuum chamber inlet 204 is sealed (e.g., by a valve) or is in fluid communication through the inlet pipe 214 with a sealed environment (e.g., piping from a toilet and/or sink), the vacuum pump system 183 or 294 is operable to purge or evacuate the vacuum chamber 202 to build up a vacuum charge in the vacuum chamber 202. When the waste container 182 and the vacuum pump system 183 or 294 are installed on the watercraft 102 and the inlet pipe 214 is in fluid communication with a waste source such as a toilet and/or sink onboard the watercraft 102, such a vacuum charge in the vacuum chamber 202 may be used to pull waste and/or other fluids from the toilet or sink into the vacuum chamber 202. For example, if the inlet pipe 214 is in fluid communication with piping from a toilet, and the piping is releasably sealed between the toilet and the inlet pipe 214 to allow a vacuum charge to be built up in the vacuum chamber 202, when a user flushes the toilet, the seal may be temporarily disengaged such that the vacuum charge may pull any waste from the toilet into the vacuum chamber 202. The vacuum pump system 183 or 294 may then transfer this additional waste from the vacuum chamber 202 to the main chamber 198, and (once the releasable seal in the piping has been re-engaged) may once again build up the vacuum charge in the vacuum chamber 202 in preparation for a subsequent use.

The following non-limiting examples are illustrative of embodiments of the present disclosure.

### Example 1: Dye Dispersion Test

In this example, a dye was used to assess dispersion of fluids during tilting motion in waste containers similar to the waste container 104 of the embodiment of FIGS. 2 to 8, having different configurations of projections similar to the projections 128, 130, 132, 134, 136, 138, 140, 142, 144, 146, 148, 150, 152, 154, 156, 158, 160, 162, 164, 166, 168, 170, 172, and 174. More specifically, dye dispersion during tilting motion was assessed in waste containers having:
a) no projections (control);
b) parallel projections spaced apart from each other at a fixed projection spacing of 2 inches and having a depth of 1.25 inches;
c) parallel projections spaced apart from each other at a fixed projection spacing of 1 inch and having a depth of 1.25 inches;
d) parallel projections spaced apart from each other at a fixed projection spacing of 1 inch and having alternating depths of 0.5 and 1.25 inches;
e) parallel projections spaced apart from each other at a fixed projection spacing of 2 inches and having a depth of 0.5 inches; and
f) parallel projections spaced apart from each other at a fixed projection spacing of 1 inch and having a depth of 0.5 inches.

In each case, a dye was added to the waste container, tilting motion of the waste container was initiated, and a time to complete dispersion of the dye was measured. The results of these measurements are summarized in Table 1.

TABLE 1
Time to Complete Dispersion of Dye During Tilting Motion

| Waste Container Configuration | Time to Complete Dispersion (sec) |
|---|---|
| No projections (control) | 91 |
| 1.25″ projections, 2″ spacing | 15.25 |
| 1.25″ projections, 1″ spacing | 12.5 |
| 1.25″/0.5″ projections, 1″ spacing | 15 |
| 0.5″ projections, 2″ spacing | 30.5 |
| 0.5″ projections, 1″ spacing | 32.75 |

As shown in Table 1, without projections (control configuration), complete dispersion requires approximately a minute and a half, while with 1.25 inch projections, complete dispersion requires only 12 to 15 seconds. This represents an approximate 80% decrease in time to complete dispersion.

The effect of decreasing projection spacing, and thus increasing projection density, was less pronounced. A drop from 2 inch spacing to 1 inch spacing, representing a doubling of the total number of projections, provided only a limited increase in effectiveness for a large increase in material use, tooling cost, and complexity of production. However, the effect of increasing the projection depth from 0.5 inches to 1.25 inches yielded a much larger increase in turbulent flow, dispersion, and mixing of the fluid in the tank.

### Example 2: Solids Breakdown Test

In this example, mixtures of water and macerated marine toilet paper were used to assess and compare capacities for dispersing suspended solids during motion in a waste container having no projections (control) and in a waste container with parallel projections spaced apart from each other at a fixed projection spacing of 2 inches and having a depth of 1.25 inches. In each case, the mixture was added to the respective container and allowed to reach equilibrium, with the macerated toilet paper settling at the bottom of the container. Then, the container was subjected to a tilting/sloshing motion, and the behaviour of the mixture inside was recorded. In the control container without projections, little to no movement of the macerated toilet paper was observed, and the macerated toilet paper remained at the bottom of the container for an entire duration of the test (approximately 112minutes). Conversely, in the container with 1.25 inch projections spaced at 2 inches, within a minute of sloshing, the macerated toilet paper was observed to have fully dispersed in the container and become suspended in the water. The mixture remained this way for the remainder of the test. It was also observed that turbulent flow created between each projection appeared to create a mixing action, which appeared to resuspend previously suspended solids at the bottom of the container when the tilting motion was applied.

These results appear to show that, compared to a waste container having no projections, a waste container having projections such as the projections 128, 130, 132, 134, 136, 138, 140, 142, 144, 146, 148, 150, 152, 154, 156, 158, 160, 162, 164, 166, 168, 170, 172, and 174 of the waste container 104 of the embodiment of FIGS. 2 to 8 increases a dispersion of suspended solids in the container and prevents settling of semi-suspended solids.

### Clauses

This disclosure includes but is not limited to the following clauses, which may be combined with other subject matter in this specification.
1. A waste container for use on a vehicle, the waste container comprising:

at least one wall comprising an inner surface defining a chamber for holding waste; and

a plurality of projections projecting from the inner surface of the at least one wall into the chamber.
2. The waste container of clause 1 wherein the projections are configured to disturb flow of the waste in the chamber as movement of the vehicle causes the waste in the chamber to move in the chamber.
3. The waste container of clause 2 wherein the projections are configured to generate turbulence in the waste in the chamber as the movement of the vehicle causes the waste in the chamber to move in the chamber.
4. The waste container of clause 2 or 3 wherein the projections are configured to break apart solids in the waste in the chamber as the movement of the vehicle causes the waste in the chamber to move in the chamber.
5. The waste container of clause 2, 3, or 4 wherein the projections are configured to disperse particles in the waste in the chamber as the movement of the vehicle causes the waste in the chamber to move in the chamber.
6. The waste container of any one of clauses 2 to 5 wherein the movement of the vehicle comprises tilting of the vehicle.
7. The waste container of any one of clauses 1 to 6 wherein at least one of the plurality of projections extends along the inner surface without contacting any other one of the plurality of projections.
8. The waste container of any one of clauses 1 to 7 wherein each of the plurality of projections extends along the inner surface without contacting any other one of the plurality of projections.
9. The waste container of any one of clauses 1 to 8 wherein at least some of the plurality of projections extend along the inner surface parallel to one another.
10. The waste container of clause 9 wherein adjacent ones of the plurality of projections along the inner surface, which extend parallel to one another along the inner surface, are spaced apart from one another at a fixed projection spacing in a spacing direction along the inner surface, the spacing direction perpendicular to an extension direction along the inner surface of the adjacent ones of the plurality of projections.
11. The waste container of clause 10 wherein the projection spacing is at most 1 inch.
12. The waste container of clause 10 wherein the projection spacing is about 1 inch.
13. The waste container of clause 10 wherein the projection spacing is at least 1 inch.
14. The waste container of clause 10 or 13 wherein the projection spacing is at most 2 inches.
15. The waste container of clause 10 wherein the projection spacing is about 2 inches.
16. The waste container of any one of clauses 1 to 15 wherein each of the plurality of projections extends along the inner surface in a substantially vertical or vertical direction when the waste container is installed on the vehicle.
17. The waste container of any one of clauses 1 to 16 wherein each of the plurality of projections projects from a respective portion of the inner surface in a respective projection direction generally orthogonal or orthogonal to the respective portion of the inner surface.
18. The waste container of any one of clauses 1 to 17 wherein at least a portion of each of the plurality of projections projects at least 0.5 inches from the inner surface.
19. The waste container of clause 18 wherein all of each of the plurality of projections projects at least 0.5 inches from the inner surface.
20. The waste container of any one of clauses 1 to 19 wherein at least a portion of each of the plurality of projections projects about 0.5 inches from the inner surface.
21. The waste container of clause 20 wherein all of each of the plurality of projections projects about 0.5 inches from the inner surface.
22. The waste container of any one of clauses 1 to 19 wherein at least a portion of each of the plurality of projections projects at least 1.25 inches from the inner surface.
23. The waste container of clause 22 wherein all of each of the plurality of projections projects at least 1.25 inches from the inner surface.
24. The waste container of any one of clauses 1 to 19, 22, or 23 wherein at least a portion of each of the plurality of projections projects about 1.25 inches from the inner surface.
25. The waste container of clause 24 wherein all of each of the plurality of projections projects about 1.25 inches from the inner surface.
26. The waste container of any one of clauses 1 to 21 wherein each of the plurality of projections projects at most 0.5 inches from the inner surface.
27. The waste container of any one of clauses 1 to 25 wherein each of the plurality of projections projects at most 1.25 inches from the inner surface.
28. The waste container of any one of clauses 1 to 27 wherein the at least one wall further defines at least one opening in the chamber for conveying the waste into and out of the chamber.
29. The waste container of clause 28 wherein the at least one opening is closable.
30. The waste container of clause 28 or 29 wherein at least one of the at least one opening is at a top of the chamber or a bottom of the chamber when the waste container is installed on the vehicle.
31. The waste container of clause 28, 29, or 30 wherein the at least one opening comprises:

at least one inlet for receiving the waste into the chamber; and

at least one outlet for removing the waste from the chamber.
32. The waste container of clause 31, when dependent from clause 30, wherein the at least one outlet comprises a bottom outlet positioned to be at the bottom of the chamber when the waste container is installed on the vehicle.
33. The waste container of clause 32 further comprising a valve operable to reversibly close the bottom outlet.
34. The waste container of clause 33 wherein the valve is a ball valve.
35. The waste container of clause 32, 33, or 34 wherein the bottom outlet is configured to be in fluid communication with a seacock on a hull of the vehicle when the waste container is installed on the vehicle.
36. The waste container of clause 31, when dependent from clause 30, or of any one of clauses 32 to 35 wherein the at least one outlet comprises a top outlet positioned to be at the top of the chamber when the waste container is installed on the vehicle.
37. The waste container of clause 36 further comprising a dip tube extending from the top outlet into the chamber, the dip tube in fluid communication with the top outlet and with the chamber.
38. The waste container of clause 36 or 37 wherein the top outlet is configured to be in fluid communication with a pump-out fitting of the vehicle when the waste container is installed on the vehicle.
39. The waste container of clause 31, when dependent from clause 30, or of any one of clauses 32 to 38 wherein the at least one inlet comprises a top inlet positioned to be at the top of the chamber when the waste container is installed on the vehicle.
40. The waste container of any one of clauses 31 to 39 wherein the at least one inlet is configured to be in fluid communication with a toilet onboard the vehicle when the waste container is installed on the vehicle.
41. The waste container of any one of clauses 31 to 40 wherein the at least one inlet is configured to be in fluid communication with a sink onboard the vehicle when the waste container is installed on the vehicle.
42. The waste container of any one of clauses 31 to 41 wherein the at least one inlet is configured to be in fluid communication with a shower onboard the vehicle when the waste container is installed on the vehicle.
43. The waste container of any one of clauses 31 to 42 wherein each of the plurality of projections extends along at least a portion of the inner surface between one of the at least one inlet and one of the at least one outlet.
44. The waste container of any one of clauses 1 to 43 wherein the at least one wall comprises a plurality of walls.
45. The waste container of clause 44 wherein at least some of the plurality of walls are parallel to one another.
46. The waste container of clause 44 or 45 wherein at least one of the plurality of projections projects from each of the plurality of walls.
47. The waste container of clause 44 or 45 wherein none of the plurality of projections project from at least one of the plurality of walls.
48. The waste container of any one of clauses 1 to 47 wherein the vehicle is a marine vessel.
49. The waste container of any one of clauses 1 to 48 installed on the vehicle.
50. A method of manufacturing the waste container of any one of clauses 1 to 48, the method comprising molding the at least one wall with the plurality of projections.
51. A method of manufacturing the waste container of any one of clauses 1 to 48, the method comprising:

molding the at least one wall; and

fixing the plurality of projections to the inner surface.
52. The method of clause 50 or 51 wherein molding the at least one wall comprises rotational molding the at least one wall.
53. The method of clause 50, 51, or 52 wherein molding the at least one wall comprises injection molding the at least one wall.
54. A system comprising:

the waste container of any one of clauses 1 to 48; and

the vehicle,

wherein the waste container is installed on the vehicle.
55. Use of the waste container of any one of clauses 1 to 48 for waste management on the vehicle.
56. A valve apparatus for controlling flow of waste into or out of a waste container, the valve apparatus comprising:

a non-dismantlable valve body defining a flow channel for conveying the waste, the flow channel comprising a channel inlet for receiving the waste into the flow channel and a channel outlet for removing the waste from the flow channel; and

at least one check valve secured within the flow channel, the at least one check valve configured to:
allow the waste to flow through the flow channel in a forward flow direction from the channel inlet to the channel outlet; and
prevent the waste from flowing through the flow channel in a reverse flow direction from the channel outlet to the channel inlet.
57. The valve apparatus of clause 56 for use with a pump for controlling the flow of the waste into or out of the waste container.
58. The valve apparatus of clause 57 wherein the pump comprises a vacuum pump.
59. The valve apparatus of clause 56, 57, or 58 wherein the valve body comprises an inlet end defining the channel inlet, the inlet end connectable to a waste source to cause the flow channel to be in fluid communication with the waste source through the channel inlet.
60. The valve apparatus of clause 59 further comprising a channel inlet clamp operable to releasably secure the inlet end to the waste source to connect the inlet end to the waste source to cause the flow channel to be in fluid communication with the waste source through the channel inlet.
61. The valve apparatus of clause 59 or 60 wherein the inlet end comprises at least one inlet end interlocking portion, the at least one inlet end interlocking portion releasably interlockable with a corresponding waste source interlocking portion of the waste source to releasably secure the inlet end to the waste source to connect the inlet end to the waste source to cause the flow channel to be in fluid communication with the waste source through the channel inlet.
62. The valve apparatus of clause 61 wherein the at least one inlet end interlocking portion is releasably interlockable with the waste source interlocking portion by rotation of the valve apparatus relative to the waste source.
63. The valve apparatus of clause 62 wherein the rotation of the valve apparatus relative to the waste source is around an inlet channel axis parallel to the flow channel at the channel inlet.
64. The valve apparatus of clause 61, 62, or 63 wherein the at least one inlet end interlocking portion projects from the valve body at the inlet end.
65. The valve apparatus of clause 64 wherein the at least one inlet end interlocking portion projects out from the valve body away from the flow channel.
66. The valve apparatus of any one of clauses 59 to 65 wherein the inlet end comprises an inlet end mating surface around the channel inlet, the inlet end mating surface configured to engage with a corresponding waste source mating surface of the waste source when the inlet end is connected to the waste source to cause the flow channel to be in fluid communication with the waste source through the channel inlet.
67. The valve apparatus of clause 66 further comprising a channel inlet seal seated on the inlet end mating surface around the channel inlet, the channel inlet seal configured to seal an interface between the inlet end mating surface and the waste source mating surface when the inlet end mating surface engages with the waste source mating surface.
68. The valve apparatus of clause 67 wherein the channel inlet seal comprises a face seal.
69. The valve apparatus of clause 67 or 68 wherein the channel inlet seal comprises an O-ring.
70. The valve apparatus of any one of clauses 59 to 69 wherein the waste source comprises the waste container.
71. The valve apparatus of any one of clauses 59 to 69 when directly or indirectly dependent from clause 57 wherein the waste source comprises the vacuum pump.
72. The valve apparatus of any one of clauses 56 to 71 wherein the valve body comprises an outlet end defining the channel outlet, the outlet end connectable to a waste destination to cause the flow channel to be in fluid communication with the waste destination through the channel outlet.
73. The valve apparatus of clause 72 further comprising a channel outlet clamp operable to releasably secure the outlet end to the waste destination to connect the outlet end to the waste destination to cause the flow channel to be in fluid communication with the waste destination through the channel outlet.
74. The valve apparatus of clause 72 or 73 wherein the outlet end comprises at least one outlet end interlocking portion, the at least one outlet end interlocking portion releasably interlockable with a corresponding waste destination interlocking portion of the waste destination to releasably secure the outlet end to the waste destination to connect the outlet end to the waste destination to cause the flow channel to be in fluid communication with the waste destination through the channel outlet.
75. The valve apparatus of clause 74 wherein the at least one outlet end interlocking portion is releasably interlockable with the waste destination interlocking portion by rotation of the valve apparatus relative to the waste destination.
76. The valve apparatus of clause 75 wherein the rotation of the valve apparatus relative to the waste destination is around an outlet channel axis parallel to the flow channel at the channel outlet.
77. The valve apparatus of clause 74, 75, or 76 wherein the at least one outlet end interlocking portion projects from the valve body at the outlet end.
78. The valve apparatus of clause 77 wherein the at least one outlet end interlocking portion projects out from the valve body away from the flow channel.
79. The valve apparatus of any one of clauses 72 to 78 wherein the outlet end comprises an outlet end mating surface around the channel outlet, the outlet end mating surface configured to engage with a corresponding waste destination mating surface of the waste destination when the outlet end is connected to the waste destination to cause the flow channel to be in fluid communication with the waste destination through the channel outlet.
80. The valve apparatus of clause 79 further comprising a channel outlet seal seated on the outlet end mating surface around the channel outlet, the channel outlet seal configured to seal an interface between the outlet end mating surface and the waste destination mating surface when the outlet end mating surface engages with the waste destination mating surface.
81. The valve apparatus of clause 80 wherein the channel outlet seal comprises a face seal.
82. The valve apparatus of clause 80 or 81 wherein the channel outlet seal comprises an O-ring.
83. The valve apparatus of any one of clauses 72 to 82 wherein the waste destination comprises the waste container.
84. The valve apparatus of any one of clauses 72 to 82 when directly or indirectly dependent from clause 57 wherein the waste destination comprises the vacuum pump.
85. The valve apparatus of any one of clauses 56 to 84 wherein the valve body comprises a plurality of valve body portions between the channel inlet and the channel outlet, the plurality of valve body portions collectively defining the flow channel, each valve body portion of the plurality of valve body portions fixed to at least one other valve body portion of the plurality of valve body portions.
86. The valve apparatus of clause 85 wherein at least two of the valve body portions of the plurality of valve body portions are fixed together by plastic welding.
87. The valve apparatus of clause 85 or 86 wherein at least two of the valve body portions of the plurality of valve body portions are fixed together by glue.
88. The valve apparatus of clause 85, 86, or 87 wherein at least one valve body portion of the plurality of valve body portions retains the check valve.
89. The valve apparatus of any one of clauses 56 to 88 wherein the at least one check valve comprises at least one duckbill valve.
90. The valve apparatus of clause 89 wherein the at least one duckbill valve comprises a first duckbill valve and a second duckbill valve.
91. The valve apparatus of clause 90 wherein the first duckbill valve and the second duckbill valve are non-overlapping in the forward flow direction.
92. The valve apparatus of clause 90 wherein at least a portion of the first duckbill valve is received in the second duckbill valve.
93. The valve apparatus of clause 92 wherein the first duckbill valve is nested within the second duckbill valve.
94. The valve apparatus of any one of clauses 56 to 93 for controlling the flow of the waste into or out of the waste container of any one of clauses 1 to 48.
95. A method of installing the valve apparatus of clause 60 or of any one of clauses 61 to 93 when directly or indirectly dependent from clause 60 to the waste source, the method comprising:

causing the channel inlet clamp to the secure the inlet end to the waste source.
96. A method of installing the valve apparatus of clause 62 or 63 or of any one of clauses 64 to 93 when directly or indirectly dependent from clause 62 to the waste source, the method comprising:

rotating the valve apparatus relative to the waste source to interlock the at least one inlet end interlocking portion with the waste source interlocking portion.
97. A method of installing the valve apparatus of clause 73 or of any one of clauses 74 to 93 when directly or indirectly dependent from clause 73 to the waste destination, the method comprising:

causing the channel outlet clamp to the secure the outlet end to the waste destination.
98. A method of installing the valve apparatus of clause 75 or 76 or of any one of clauses 77 to 93 when directly or indirectly dependent from clause 75 to the waste destination, the method comprising:

rotating the valve apparatus relative to the waste destination to interlock the at least one outlet end interlocking portion with the waste destination interlocking portion.
99. A system comprising:

the valve apparatus of any one of clauses 56 to 93; and

the waste container,

wherein:
the waste container comprises at least one wall comprising an inner surface defining a chamber for holding the waste; and
the flow channel of the valve apparatus is in fluid communication with the chamber of the waste container.
100. The system of clause 99 wherein:

the at least one wall of the waste container defines a container outlet for removing the waste from the waste container; and

the flow channel of the valve apparatus is in fluid communication with the chamber of the waste container through the container outlet of the waste container and through the channel inlet of the valve apparatus.
101. The system of clause 100 when directly or indirectly dependent from clause 59 wherein the inlet end of the valve apparatus is connected to the waste container at the container outlet of the waste container.
102. The system of clause 101 when directly or indirectly dependent from clause 60 wherein the channel inlet clamp of the valve apparatus releasably secures the inlet end of the valve apparatus to the waste container at the container outlet of the waste container.
103. The system of clause 101 or 102 when directly or indirectly dependent from clause 61 wherein the waste container further comprises at least one waste container outlet interlocking portion at the container outlet, the at least one waste container outlet interlocking portion releasably interlocked with a corresponding one of the at least one inlet end interlocking portion of the inlet end of the valve apparatus to releasably secure the inlet end of the valve apparatus to the waste container at the container outlet of the waste container.
104. The system of clause 101, 102, or 103 when directly or indirectly dependent from clause 66 wherein the inlet end mating surface of the valve apparatus engages with a corresponding container outlet mating surface of the waste container.
105. The system of clause 104 when directly or indirectly dependent from clause 67 wherein the channel inlet seal of the valve apparatus seals an interface between the inlet end mating surface of the valve apparatus and the container outlet mating surface of the waste container.
106. The system of clause 99 wherein:

the at least one wall of the waste container defines a container inlet for receiving the waste into the waste container; and

the flow channel of the valve apparatus is in fluid communication with the waste container through the container inlet of the waste container and through the channel outlet of the valve apparatus.
107. The system of clause 106 when directly or indirectly dependent from clause 72 wherein the outlet end of the valve apparatus is connected to the waste container at the container inlet of the waste container.
108. The system of clause 107 when directly or indirectly dependent from clause 73 wherein the channel outlet clamp of the valve apparatus releasably secures the outlet end of the valve apparatus to the waste container at the container inlet of the waste container.
109. The system of clause 107 or 108 when directly or indirectly dependent from clause 74 wherein the waste container further comprises at least one waste container inlet interlocking portion at the container inlet, the at least one waste container inlet interlocking portion releasably interlocked with a corresponding one of the at least one outlet end interlocking portion of the outlet end of the valve apparatus to releasably secure the outlet end of the valve apparatus to the waste container at the container inlet of the waste container.
110. The system of clause 107, 108, or 109 when directly or indirectly dependent from clause 79 wherein the outlet end mating surface of the valve apparatus engages with a corresponding container inlet mating surface of the waste container.
111. The system of clause 110 when directly or indirectly dependent from clause 80 wherein the channel outlet seal of the valve apparatus seals an interface between the outlet end mating surface of the valve apparatus and the container inlet mating surface of the waste container.
112. The system of any one of clauses 99 to 111 wherein the waste container comprises the waste container of any one of clauses 1 to 48.
113. A vacuum pump system for controlling flow of waste into or out of a waste container, the vacuum pump system comprising:

a vacuum pump operable to cause the waste to flow, the vacuum pump defining a pump inlet for receiving the waste into the vacuum pump and a pump outlet for removing the waste from the vacuum pump; and

a first one of the valve apparatus of any one of clauses 56 to 93,

wherein the flow channel of the first one of the valve apparatus is in fluid communication with the vacuum pump.
114. The vacuum pump system of clause 113 wherein the flow channel of the first one of the valve apparatus is in fluid communication with the vacuum pump through the pump outlet of the vacuum pump and through the channel inlet of the first one of the valve apparatus.
115. The vacuum pump system of clause 114 when directly or indirectly dependent from clause 59 wherein the inlet end of the first one of the valve apparatus is connected to the vacuum pump at the pump outlet of the vacuum pump.
116. The vacuum pump system of clause 115 when directly or indirectly dependent from clause 60 wherein the channel inlet clamp of the first one of the valve apparatus releasably secures the inlet end of the first one of the valve apparatus to the vacuum pump at the pump outlet of the vacuum pump.
117. The vacuum pump system of clause 115 or 116 when directly or indirectly dependent from clause 61 wherein the vacuum pump further comprises at least one vacuum pump outlet interlocking portion at the pump outlet, the at least one vacuum pump outlet interlocking portion releasably interlocked with a corresponding one of the at least one inlet end interlocking portion of the inlet end of the first one of the valve apparatus to releasably secure the inlet end of the first one of the valve apparatus to the vacuum pump at the pump outlet of the vacuum pump.
118. The vacuum pump system of clause 115, 116, or 117 when directly or indirectly dependent from clause 66 wherein the inlet end mating surface of the first one of the valve apparatus engages with a corresponding pump outlet mating surface of the vacuum pump.
119. The vacuum pump system of clause 118 when directly or indirectly dependent from clause 67 wherein the channel inlet seal of the first one of the valve apparatus seals an interface between the inlet end mating surface of the first one of the valve apparatus and the pump outlet mating surface of the vacuum pump.
120. The vacuum pump system of clause 113 wherein the flow channel of the first one of the valve apparatus is in fluid communication with the vacuum pump through the pump inlet of the vacuum pump and through the channel outlet of the first one of the valve apparatus.
121. The vacuum pump system of clause 120 when directly or indirectly dependent from clause 72 wherein the outlet end of the first one of the valve apparatus is connected to the vacuum pump at the pump inlet of the vacuum pump.
122. The vacuum pump system of clause 121 when directly or indirectly dependent from clause 73 wherein the channel outlet clamp of the first one of the valve apparatus releasably secures the outlet end of the first one of the valve apparatus to the vacuum pump at the pump inlet of the vacuum pump.
123. The vacuum pump system of clause 121 or 122 when directly or indirectly dependent from clause 74 wherein the vacuum pump further comprises at least one vacuum pump inlet interlocking portion at the pump inlet, the at least one vacuum pump inlet interlocking portion releasably interlocked with a corresponding one of the at least one outlet end interlocking portion of the outlet end of the first one of the valve apparatus to releasably secure the outlet end of the first one of the valve apparatus to the vacuum pump at the pump inlet of the vacuum pump.
124. The vacuum pump system of clause 121, 122, or 123 when directly or indirectly dependent from clause 79 wherein the outlet end mating surface of the first one of the valve apparatus engages with a corresponding pump inlet mating surface of the vacuum pump.
125. The vacuum pump system of clause 124 when directly or indirectly dependent from clause 80 wherein the channel outlet seal of the first one of the valve apparatus seals an interface between the outlet end mating surface of the first one of the valve apparatus and the pump inlet mating surface of the vacuum pump.
126. The vacuum pump system of any one of clauses 120 to 125 further comprising a second one of the valve apparatus of any one of clauses 56 to 93, wherein the flow channel of the second one of the valve apparatus is in fluid communication with the vacuum pump through the pump outlet of the vacuum pump and through the channel inlet of the second one of the valve apparatus.
127. The vacuum pump system of clause 126 when directly or indirectly dependent from clause 59 wherein the inlet end of the second one of the valve apparatus is connected to the vacuum pump at the pump outlet of the vacuum pump.
128. The vacuum pump system of clause 127 when directly or indirectly dependent from clause 60 wherein the channel inlet clamp of the second one of the valve apparatus releasably secures the inlet end of the second one of the valve apparatus to the vacuum pump at the pump outlet of the vacuum pump.
129. The vacuum pump system of clause 128 when directly or indirectly dependent from clause 61 wherein the vacuum pump further comprises at least one vacuum pump outlet interlocking portion at the pump outlet, the at least one vacuum pump outlet interlocking portion releasably interlocked with a corresponding one of the at least one inlet end interlocking portion of the inlet end of the second one of the valve apparatus to releasably secure the inlet end of the second one of the valve apparatus to the vacuum pump at the pump outlet of the vacuum pump.
130. The vacuum pump system of clause 127, 128, or 129 when directly or indirectly dependent from clause 66 wherein the inlet end mating surface of the second one of the valve apparatus engages with a corresponding pump outlet mating surface of the vacuum pump.
131. The vacuum pump system of clause 130 when directly or indirectly dependent from clause 67 wherein the channel inlet seal of the second one of the valve apparatus seals an interface between the inlet end mating surface of the second one of the valve apparatus and the pump outlet mating surface of the vacuum pump.
132. The vacuum pump system of any one of clauses 113 to 131 for controlling the flow of the waste into or out of the waste container of any one of clauses 1 to 48.
133. A system comprising:

the vacuum pump system of any one of clauses 113 to 131; and

the waste container,

wherein:
the waste container comprises at least one wall comprising an inner surface defining a chamber for holding the waste; and
the vacuum pump system is in fluid communication with the chamber of the waste container.
134. The system of clause 133 wherein the flow channel of the first one of the valve apparatus of the vacuum pump system is in fluid communication with the chamber of the waste container.
135. The system of clause 134 when directly or indirectly dependent from clause 114 wherein:

the at least one wall of the waste container defines a container inlet for receiving the waste into the waste container; and

the flow channel of the first one of the valve apparatus of the vacuum pump system is in fluid communication with the chamber of the waste container through the container inlet of the waste container and through the channel outlet of the first one of the valve apparatus of the vacuum pump system.
136. The system of clause 135 when directly or indirectly dependent from clause 72 wherein the outlet end of the first one of the valve apparatus of the vacuum pump system is connected to the waste container at the container inlet of the waste container.
137. The system of clause 136 when directly or indirectly dependent from clause 73 wherein the channel outlet clamp of the first one of the valve apparatus of the vacuum pump system releasably secures the outlet end of the first one of the valve apparatus of the vacuum pump system to the waste container at the container inlet of the waste container.
138. The system of clause 136 or 137 when directly or indirectly dependent from clause 74 wherein the waste container further comprises at least one waste container inlet interlocking portion at the container inlet, the at least one waste container inlet interlocking portion releasably interlocked with a corresponding one of the at least one outlet end interlocking portion of the outlet end of the first one of the valve apparatus to releasably secure the outlet end of the first one of the valve apparatus to the waste container at the container inlet of the waste container.
139. The system of clause 136, 137, or 138 when directly or indirectly dependent from clause 79 wherein the outlet end mating surface of the first one of the valve apparatus of the vacuum pump system engages with a corresponding container inlet mating surface of the waste container.
140. The system of clause 139 when directly or indirectly dependent from clause 80 wherein the channel outlet seal of the first one of the valve apparatus of the vacuum pump system seals an interface between the outlet end mating surface of the first one of the valve apparatus of the vacuum pump system and the container inlet mating surface of the waste container.
141. The system of clause 134 when directly or indirectly dependent from clause 120 wherein:

the at least one wall of the waste container defines a container outlet for receiving the waste into the waste container; and

the flow channel of the first one of the valve apparatus of the vacuum pump system is in fluid communication with the chamber of the waste container through the container outlet of the waste container and through the channel inlet of the first one of the valve apparatus of the vacuum pump system.
142. The system of clause 141 when directly or indirectly dependent from clause 59 wherein the inlet end of the first one of the valve apparatus of the vacuum pump system is connected to the waste container at the container outlet of the waste container.
143. The system of clause 142 when directly or indirectly dependent from clause 60 wherein the channel inlet clamp of the first one of the valve apparatus of the vacuum pump system releasably secures the inlet end of the first one of the valve apparatus of the vacuum pump system to the waste container at the container outlet of the waste container.
144. The system of clause 142 or 143 when directly or indirectly dependent from clause 61 wherein the waste container further comprises at least one waste container outlet interlocking portion at the container outlet, the at least one waste container outlet interlocking portion releasably interlocked with a corresponding one of the at least one inlet end interlocking portion of the inlet end of the first one of the valve apparatus to releasably secure the inlet end of the first one of the valve apparatus to the waste container at the container outlet of the waste container.
145. The system of clause 142, 143, or 144 when directly or indirectly dependent from clause 66 wherein the inlet end mating surface of the first one of the valve apparatus of the vacuum pump system engages with a corresponding container outlet mating surface of the waste container.
146. The system of clause 145 when directly or indirectly dependent from clause 67 wherein the channel inlet seal of the first one of the valve apparatus of the vacuum pump system seals an interface between the inlet end mating surface of the first one of the valve apparatus of the vacuum pump system and the container outlet mating surface of the waste container.
147. The system of clause 133 when directly or indirectly dependent from clause 126 wherein:

the at least one wall of the waste container defines a container inlet for receiving the waste into the waste container; and

the flow channel of the second one of the valve apparatus of the vacuum pump system is in fluid communication with the chamber of the waste container through the container inlet of the waste container and through the channel outlet of the second one of the valve apparatus of vacuum pump system.
148. The system of clause 147 when directly or indirectly dependent from clause 72 wherein the outlet end of the second one of the valve apparatus of the vacuum pump system is connected to the waste container at the container inlet of the waste container.
149. The system of clause 148 when directly or indirectly dependent from clause 73 wherein the channel outlet clamp of the second one of the valve apparatus of the vacuum pump system releasably secures the outlet end of the second one of the valve apparatus of the vacuum pump system to the waste container at the container inlet of the waste container.
150. The system of clause 148 or 149 when directly or indirectly dependent from clause 74 wherein the waste container further comprises at least one waste container inlet interlocking portion at the container inlet, the at least one waste container inlet interlocking portion releasably interlocked with a corresponding one of the at least one outlet end interlocking portion of the outlet end of the second one of the valve apparatus to releasably secure the outlet end of the second one of the valve apparatus to the waste container at the container inlet of the waste container.
151. The system of clause 148, 149, or 150 when directly or indirectly dependent from clause 79 wherein the outlet end mating surface of the second one of the valve apparatus of the vacuum pump system engages with a corresponding container inlet mating surface of the waste container.
152. The system of clause 151 when directly or indirectly dependent from clause 80 wherein the channel outlet seal of the second one of the valve apparatus of the vacuum pump system seals an interface between the outlet end mating surface of the second one of the valve apparatus of the vacuum pump system and the container inlet mating surface of the waste container.
153. The system of any one of clauses 133 to 152 wherein the waste container comprises the waste container of any one of clauses 1 to 48.
154. A kit comprising:

the waste container of any one of clauses 1 to 48; and

at least one of the valve apparatus of any one of clauses 56 to 93.
155. The kit of clause 154 further comprising a pump.
156. The kit of clause 155 wherein the pump comprises a vacuum pump.
157. The kit of clause 155 or 156 wherein the at least one of the valve apparatus of any one of clauses 56 to 93 comprises at least two of the valve apparatus of any one of clauses 56 to 93.

Although specific embodiments have been described and illustrated, such embodiments should be considered illustrative only and not as limiting the invention as construed according to the accompanying claims.

1. A valve apparatus for controlling flow of waste into or out of a waste container, the valve apparatus comprising:
a non-dismantlable valve body defining a flow channel for conveying the waste, the flow channel comprising a channel inlet for receiving the waste into the flow channel and a channel outlet for removing the waste from the flow channel; and
at least one check valve secured within the flow channel, the at least one check valve configured to:
allow the waste to flow through the flow channel in a forward flow direction from the channel inlet to the channel outlet; and
prevent the waste from flowing through the flow channel in a reverse flow direction from the channel outlet to the channel inlet.

2. The valve apparatus of claim 1 wherein the valve body comprises an inlet end defining the channel inlet, the inlet end connectable to a waste source to cause the flow channel to be in fluid communication with the waste source through the channel inlet.

3. The valve apparatus of claim 2 wherein the inlet end comprises at least one inlet end interlocking portion, the at least one inlet end interlocking portion releasably interlockable with a corresponding waste source interlocking portion of the waste source to releasably secure the inlet end to the waste source to connect the inlet end to the waste source to cause the flow channel to be in fluid communication with the waste source through the channel inlet.

4. The valve apparatus of claim 3 wherein the at least one inlet end interlocking portion is releasably interlockable with the waste source interlocking portion by rotation of the valve apparatus relative to the waste source.

5. The valve apparatus of claim 4 wherein the rotation of the valve apparatus relative to the waste source is around an inlet channel axis parallel to the flow channel at the channel inlet.

6. The valve apparatus of claim 3 wherein the at least one inlet end interlocking portion projects from the valve body at the inlet end.

7. The valve apparatus of claim 6 wherein the at least one inlet end interlocking portion projects out from the valve body away from the flow channel.

8. The valve apparatus of claim 2 wherein the inlet end comprises an inlet end mating surface around the channel inlet, the inlet end mating surface configured to engage with a corresponding waste source mating surface of the waste source when the inlet end is connected to the waste source to cause the flow channel to be in fluid communication with the waste source through the channel inlet.

9. The valve apparatus of claim 1 wherein the valve body comprises an outlet end defining the channel outlet, the outlet end connectable to a waste destination to cause the flow channel to be in fluid communication with the waste destination through the channel outlet.

10. The valve apparatus of claim 9 wherein the outlet end comprises at least one outlet end interlocking portion, the at least one outlet end interlocking portion releasably interlockable with a corresponding waste destination interlocking portion of the waste destination to releasably secure the outlet end to the waste destination to connect the outlet end to the waste destination to cause the flow channel to be in fluid communication with the waste destination through the channel outlet.

11. The valve apparatus of claim 10 wherein the at least one outlet end interlocking portion is releasably interlockable with the waste destination interlocking portion by rotation of the valve apparatus relative to the waste destination.

12. The valve apparatus of claim 11 wherein the rotation of the valve apparatus relative to the waste destination is around an outlet channel axis parallel to the flow channel at the channel outlet.

13. The valve apparatus of claim 10 wherein the at least one outlet end interlocking portion projects from the valve body at the outlet end.

14. The valve apparatus of claim 13 wherein the at least one outlet end interlocking portion projects out from the valve body away from the flow channel.

15. The valve apparatus of claim 9 wherein the outlet end comprises an outlet end mating surface around the channel outlet, the outlet end mating surface configured to engage with a corresponding waste destination mating surface of the waste destination when the outlet end is connected to the waste destination to cause the flow channel to be in fluid communication with the waste destination through the channel outlet.

16. The valve apparatus of claim 1 wherein the valve body comprises a plurality of valve body portions between the channel inlet and the channel outlet, the plurality of valve body portions collectively defining the flow channel, each valve body portion of the plurality of valve body portions fixed to at least one other valve body portion of the plurality of valve body portions.

17. The valve apparatus of claim 16 wherein at least two of the valve body portions of the plurality of valve body portions are fixed together by plastic welding.

18. The valve apparatus of claim 1 wherein the at least one check valve comprises at least one duckbill valve.

19. A method of installing the valve apparatus of claim 4 to the waste source, the method comprising:
rotating the valve apparatus relative to the waste source to interlock the at least one inlet end interlocking portion with the waste source interlocking portion.

20. A method of installing the valve apparatus of claim 11 to the waste destination, the method comprising:
rotating the valve apparatus relative to the waste destination to interlock the at least one outlet end interlocking portion with the waste destination interlocking portion.
